(19) United States
(12) Patent Application Publication
(10) Pub. No.: US 2026/0307998 A1
(43) Pub. Date: Oct. 8, 2026

(54) CARBON MATERIAL, PRODUCTION METHOD FOR CARBON MATERIAL, DISPERSION LIQUID, COMPOSITION FOR ELECTRODES, SLURRY FOR ELECTRODES, ELECTRODE, POSITIVE ELECTRODE, NEGATIVE ELECTRODE, LITHIUM ION BATTERY, CARBON MATERIAL PRECURSOR, AND PRODUCTION METHOD FOR CARBON MATERIAL PRECURSOR

(71) Applicant: 3DC INC., Sendai-shi (JP)

(72) Inventors: Hirotomo Nishihara, Sendai-shi (JP); Togo Yamaguchi, Sendai-shi (JP); Rikuto Kaku, Sendai-shi (JP); Atsushi Takase, Sendai-shi (JP); Atsuo Omaru, Sendai-shi (JP); Takashi Kiuchi, Saku-shi (JP)

(73) Assignee: 3DC INC., Sendai-shi (JP)

(21) Appl. No.: 19/479,033

(22) PCT Filed: Dec. 27, 2024
(86) PCT No.: PCT/JP2024/046488

§ 371 Date: Oct. 27, 2025

(30) Foreign Application Priority Data
Dec. 28, 2023 (JP) 2023-223523
May 1, 2024 (JP) 2024-074576

(51) Int. Cl. C01B 32/182; H01M 4/02; H01M 4/38; H01M 4/583; H01M 4/62; H01M 10/0525

(52) U.S. Cl. CPC C01B 32/182; H01M 4/386; H01M 4/583; H01M 4/625; H01M 10/0525; C01P 2002/60; C01P 2002/82; C01P 2004/04; C01P 2004/51; C01P 2006/10; C01P 2006/12; C01P 2006/14; C01P 2006/16; C01P 2006/19; H01M 2004/021; H01M 2004/027; H01M 2004/028

(57) ABSTRACT

The present invention relates to a carbon material having a combined structure with an elongated form in which a plurality of hollow particulate units are connected in a bead-chain-like configuration. Each of the hollow particulate units includes a surrounding wall that defines an enclosed internal space, the surrounding wall having a plurality of pores and possessing a graphene crystal structure. The carbon material exhibits an intensity ratio (I_{G}/I_{2D}) of the intensity of a G band (I_{G}) to the intensity of a 2D band (I_{2D}) in a Raman spectrum obtained by Raman spectrometry of 0.40 or greater and 5.00 or less. Furthermore, the carbon material has an oil absorption of 400 mL/100 g or greater in accordance with JIS K 5101-13-1:2004.

### TECHNICAL FIELD

The present invention relates to a carbon material and a method for producing the same, a dispersion liquid, a composition for an electrode, a slurry for an electrode, an electrode, a lithium ion battery, as well as a carbon material precursor and a method for producing the same.

### BACKGROUND ART

Various carbon materials have been studied thus far. For example, carbon black has been used in a wide range of fields.

As a type of nanocarbons, carbon nanotubes have high mechanical strength and electrical conductivity. However, since a plurality of carbon nanotubes tend to be agglomerated or entangled, the plurality of carbon nanotubes needs to be dispersed. Furthermore, it is not easy to increase uniformity of a physical property or of a shape in the plurality of carbon nanotubes.

Graphene, which is a different type of nanocarbon from carbon nanotube, has high mechanical strength and electrical conductivity, as well as high flexibility. Therefore, the graphene is expected to find applications in a variety of fields.

For example, Patent Document 1 describes a carbon material for an energy storage device having a graphene laminated structure, a BET specific surface area of 80 to 155 m²/g, a volume of pores of 0.3 nm or more and 1.0 nm or less in diameter in a pore size distribution of 1.6 to 2.1 mL/g, and a DBP absorption of 210 to 220 mL/100 g. The carbon material in Patent Document 1 has a graphene laminated structure, high DBP absorption, and an excellent liquid retainability of an electrolyte solution. Therefore, the carbon material can be applied to a positive electrode to enhance a cycle property of a battery. Thus, in Patent Document 1, a technology of applying the carbon material having the graphene laminated structure to a battery is discussed.

Incidentally, products in various fields, including batteries, are rapidly advancing in performance and functionality. As the products become more multifunctional, a performance level required for each component of the products is rapidly increasing. For example, in the field of batteries, the carbon material of Patent Document 1 does not have sufficient liquid retainability, and thus, even if the carbon material of Patent Document 1 is applied to a battery, the battery property such as a rapid discharge property or a charge-discharge property will not be sufficient. Therefore, there is a need for a carbon material that can achieve the demanded product level even when applied to an increasingly multifunctional product.

Non-patent Document 1 describes the transfer of an electrolyte solution (electrolyte motion) in a cylindrical lithium ion battery. During charging, particles of a negative electrode material expand as a lithium ion is inserted into the negative electrode material such as graphite. When the lithium ion is de-inserted at a next discharge, the particles of the negative electrode material contract, and thus the voids in the electrode change. In response to the change of the voids, the electrolyte solution is transferred, that is, the electrolyte solution present in the voids of the electrode is pushed out or re-impregnated. This non-uniformity in an amount and a location of the electrolyte solution present in the electrode is considered to be one of the causes of degradation of a charge-discharge cycle.

Although a material and a basic reaction of a positive electrode and a negative electrode are common to lithium ion batteries such as the one described in Non-Patent Document 1, there are various ways to approach battery production depending on business environment factors such as a battery application, availability of a facility, a viewpoint on manufacturing cost, and a cooperative system with another company, and, therefore, the actual situation is that batteries, electrodes, and electrolyte solutions are being devised in accordance therewith.

### CITATION LIST

### Patent Document

Patent Document 1: Japanese Unexamined Patent Application, Publication No. 2019-091587

### Non-Patent Document

Non-Patent Document 1: C. P. Aiken, et. al., Journal of The Electrochemical Society, 2023, 170, 040529

### DISCLOSURE OF THE INVENTION

### Problems to be Solved by the Invention

An object of the present invention is to provide a carbon material having a crystal structure of graphene, graphene layers controlled in a predetermined laminated state, and a high oil absorption and a method for producing the same; a dispersion liquid, a composition for an electrode, a slurry for an electrode, an electrode, a positive electrode, a negative electrode, and a lithium ion battery including the carbon material, as well as a carbon material precursor which is a precursor of the carbon material and a method for producing the same.

### Means for Solving the Problems

In order to achieve the above-described object, an outline of the present invention is provided as follows.
[1] A carbon material including a combined structure having an extended shape in which a plurality of hollow particulate parts is combined in a bead-chain-like configuration, the hollow particulate parts each including a surrounding wall that forms a comparted interior space of the hollow particulate parts and has a plurality of pores and a crystal structure of graphene, the carbon material having an intensity ratio (I_{G}/I_{2D}) of an intensity of a G band (I_{G}) to an intensity of a 2D band (I_{2D}) in a Raman spectrum obtained by Raman spectrometry of 0.40 or more and 5.00 or less, and the carbon material having an oil absorption of 400 mL/100 g or more in accordance with JIS K5101-13-1:2004.
[2] In the carbon material as described in [1], an intensity ratio (I_{D}/I_{G}) of an intensity of a D band (I_{D}) to the intensity of the G band (I_{G}) in the Raman spectrum is 0.1 or more and 10.0 or less.
[3] In the carbon material as described in [1] or [2], a mode pore size is 1 nm or more and 500 nm or less.
[4] In the carbon material as described in any one of [1] to [3], a total pore volume is 0.10 cc/g or more and 20.00 cc/g or less.
[5] In the carbon material as described in any one of [1] to [4], a ratio of a macropore volume to a total pore volume is 5% or more.
[6] In the carbon material as described in any one of [1] to [5], an apparent density is 2.00 g/cc or less.
[7] In the carbon material as described in any one of [1] to [6], a BET specific surface area is 100 m²/g or more and 2700 m²/g or less.
[8] In the carbon material as described in any one of [1] to [7], a crystallite size Lc(002) in a c-axis direction measured by an X-ray diffraction method is 0.10 nm or more and 20.00 nm or less.
[9] In the carbon material as described in any one of [1] to [8], an interplanar distance d002 between (002) planes measured by an X-ray diffraction method is 3.0 Å or more and 5.0 Å or less.
[10] In the carbon material as described in any one of [1] to [9], a D50 obtained from a volume-based particle size distribution curve measured by a laser diffraction scattering method is 1 μm or more and 100 μm or less.
[11] In the carbon material as described in any one of [1] to [10], a ratio (D90/D10) of a D90 to a D10 obtained from a volume-based particle size distribution curve measured by a laser diffraction scattering method is 100 or less.
[12] In the carbon material as described in any one of [1] to [11], a value obtained by dividing a ratio (D90/M) of a D90 obtained from a volume-based particle size distribution curve measured by a laser diffraction scattering method to a mode pore size M by 1000 is 50 or less.
[13] In the carbon material as described in any one of [1] to [12], the combined structure is a graphene mesosponge.
[14] In the carbon material as described in any one of [1] to [13], the carbon material is for use in a secondary battery.
[15] A dispersion liquid including: the carbon material as described in any one of [1] to [14]; and a dispersion medium, in which the carbon material is dispersed in the dispersion medium.
[16] A composition for an electrode including: the carbon material as described in any one of [1] to [14]; an active material; and a binder.
[17] A slurry for an electrode including: the composition for an electrode as described in [16]; and a dispersion medium; in which the composition for an electrode is dispersed in the dispersion medium.
[18] An electrode including the carbon material as described in any one of [1] to [14].
[19] In the electrode as described in [18], the electrode includes 0.1 wt % or more and 6.0 wt % or less of the carbon material.
[20] A positive electrode including the carbon material as described in any one of [1] to [14].
[21] A negative electrode including the carbon material as described in any one of [1] to [14].
[22] In the negative electrode as described in [21], the negative electrode is a negative electrode for a lithium ion battery and further includes graphite.
[23] In the negative electrode as described in [21], the negative electrode is a negative electrode for a lithium ion battery and further includes silicon.
[24]A lithium ion battery including: the positive electrode as described in [20]; the negative electrode as described in [21]; and a liquid electrolyte.
[25]A lithium ion battery including: the positive electrode as described in [20]; the negative electrode as described in [21]; and a semi-solid electrolyte.
[26] In the lithium ion battery as described in [24] or [25], at least one of the positive electrode or the negative electrode is a dry electrode.
[27]A lithium ion battery including: a clay-type positive electrode including the carbon material as described in any one of [1] to [14]; and a clay-type negative electrode including the carbon material as described in any one of [1] to [14].
[28]A lithium ion battery including the carbon material as described in any one of [1] to [14].
[29]A method for producing the carbon material as described in any one of [1] to [14] including removing a template material from a carbon material precursor to thereby obtain a carbon material, the carbon material precursor including the template material that is an agglomerate of a plurality of primary particles agglomerated in a bead-chain-like configuration and a carbonaceous layer that covers a surface of the template material.
[30] The method as described in [29], further includes heating the carbon material at a temperature of 1000° C. or more and 3000° C. or less after the removing.
[31] In the method as described in [29] or [30], the template material is a fumed compound.
[32]A carbon material precursor including: a template material composed of an agglomerate of a plurality of primary particles agglomerated in a bead-chain-like configuration; and a carbonaceous layer covering a surface of the template material and having a plurality of pores.
[33]A method for producing the carbon material precursor as described in [32] including covering a surface of a template material that is an agglomerate of a plurality of primary particles agglomerated in a bead-chain-like configuration with a carbonaceous layer to thereby obtain the carbon material precursor.
[34] In the method as described in [33], the template material is a fumed compound.

### Effects of the Invention

The present invention can provide a carbon material having a crystal structure of graphene, graphene layers controlled in a predetermined laminated state, and a high oil absorption and a method for producing the same; a dispersion liquid, a composition for an electrode, a slurry for an electrode, an electrode, a positive electrode, a negative electrode, and a lithium ion battery including the carbon material, as well as a carbon material precursor which is a precursor of the carbon material and a method for producing the same.

### BRIEF DESCRIPTION OF THE DRAWINGS

FIG. 1 is a cross-sectional view showing one exemplary lithium ion battery according to an embodiment.

FIG. 2 is an enlarged transmission electron microscope (TEM) image of Carbon material A of Example 1 as observed using TEM at an acceleration voltage of 80 kV.

FIG. 3 is a TEM image of Carbon material A of Example 1 as observed using TEM at an acceleration voltage of 100 kV.

FIG. 4 is an enlarged TEM image of Carbon material of Example 1 as observed using TEM at an acceleration voltage of 100 kV.

FIG. 5 is a graph showing discharge curves for different discharge current values using test batteries of Example 1.

FIG. 6 is a result of a Raman spectrum of Carbon material B of Example 2.

FIG. 7 is a graph showing a relationship between an oil absorption and a 2C maintenance rate for test batteries of Examples 1 and 9 and Comparative Example 1.

FIG. 8 is a graph showing a relationship of an amount of a carbon material with a 2C maintenance rate and a discharge capacity for test batteries of Examples 1 and 10 to 16.

FIG. 9 is a schematic diagram illustrating an ultra-sensitive vacuum TPD apparatus used for thermal desorption spectrometry.

### PREFERRED MODE FOR CARRYING OUT THE INVENTION

Embodiments will be described in detail.

As a result of extensive studies to achieve the above object, the present invention has been completed based on the findings that inclusion of a combined structure having an extended shape in which a plurality of hollow particulate parts is combined in a bead-chain-like configuration, the hollow particulate parts each including a surrounding wall having a predetermined configuration, and control of an intensity ratio (I_{G}/I_{2D}) in a Raman spectrum and an oil absorption to a predetermined range allow a carbon material to have a crystal structure of graphene, graphene layers controlled to a predetermined laminated state, and a high oil absorption.

### (Carbon Material)

First, a carbon material according to an embodiment will be described.

The carbon material according to the embodiment includes a combined structure having an extended shape in which a plurality of hollow particulate parts is combined in a bead-chain-like configuration, the hollow particulate parts each including a surrounding wall that forms a comparted interior space of the hollow particulate parts and has a plurality of pores and a crystal structure of graphene, the carbon material having an intensity ratio (I_{G}/I_{2D}) of an intensity of a G band (I_{G}) to an intensity of a 2D band (I_{2D}) in a Raman spectrum obtained by Raman spectrometry of 0.40 or more and 5.00 or less, and the carbon material having an oil absorption of 400 mL/100 g or more in accordance with JIS K5101-13-1:2004.

The carbon material according to an embodiment has a combined structure having an extended shape. The combined structure having the extended shape is composed of a plurality of hollow particulate parts combined in a bead-chain-like configuration. The hollow particulate parts each has a surrounding wall, and the interior of the hollow particulate parts is hollow. The surrounding wall forms a comparted interior space of the hollow particulate parts in the combined structure. The surrounding wall has a crystal structure of graphene, and a plurality of pores is formed at the surrounding wall.

The carbon material has a hollow structure. The interior spaces in the combined structure, including the interior spaces of the hollow particulate parts, are in communication with each other. Such a carbon material is porous with micropores, mesopores, and macropores.

The surrounding wall of the carbon material is preferably composed of graphene or multilayer graphene, and may be a mixture of graphene and multilayer graphene. Graphene is a sheet-like material composed of SP2-bonded carbon with a honeycomb hexagonal lattice structure formed of a series of six-membered carbon ring structures. Thus, the surrounding wall has a six-membered carbon ring structure. The combined structure is preferably graphene mesosponge (GMS).

The carbon material is composed of an elastically deformable structure and a plastically deformable structure. The plastically deformable structure is deformed and distorted by applying an external force below a predetermined value thereto, but when an external force beyond an elastic limit is applied, it is permanently distorted without returning to its original shape even after the external force is removed. A degree of elastic deformation or plastic deformation of the carbon material can be measured by an ultra-micro loading-unloading test.

The carbon material has a property of returning to its original shape without plastic deformation under a weak external force as in the case of an ultra-micro loading-unloading test, i.e., a high elastic deformation workload. For the carbon material, a part composed of graphene making up a majority of the carbon material exhibits elastic deformability, while a structural part other than graphene such as a defective part of a graphene structure or an amorphous carbon part exhibits plastic deformability, and thus the carbon material is considered to exhibit a good property against deformation by an external force. If a number of graphene layers is excessively large, the carbon material retains elastic deformability at an external force below a predetermined value, but at an external force exceeding an elastic limit, it tends to plastically deform suddenly, whereby hollow particulate parts and the like are destroyed.

The carbon material preferably has a branched part where the combined structure is branched, and more preferably has a plurality of branched parts. For the carbon material, the combined structure preferably has a ring-shaped part, and more preferably has a plurality of ring-shaped parts. The combined structure having the extended shape may have only the branched part, only the ring-shaped part, or the branched part and the ring-shaped part. For example, one end of the combined structure may be combined to the other end of the combined structure to form the ring-shaped part. Tips of branches that branch into a plurality of branches and extend may be combined to each other to form the ring-shaped part. The ring-shaped part may also be formed at a part other than ends of the combined structure.

A size of the plurality of pores of the combined structure is preferably 0.1 nm or more and 100.0 nm or less, more preferably 1.0 nm or more and 80.0 nm or less, and even more preferably 5.0 nm or more and 50.0 nm or less. A length of the combined structure is preferably 0.01 μm or more and 100.00 μm or less, more preferably 0.05 μm or more and 80.00 μm or less, and even more preferably 0.10 μm or more and 50.00 μm or less. An average particle size (average outer diameter) of the hollow particulate part of the combined structure is preferably 0.05 μm or more and 50.00 μm or less, more preferably 0.05 μm or more and 6.00 μm or less, even more preferably 0.10 μm or more and 10.00 μm or less, particularly preferably 0.10 μm or more and 5.00 μm or less, and most preferably 0.50 μm or more and 5.00 μm or less.

A combining part (bonding part) between the hollow particulate parts that are combined to each other may be provided with a neck. For example, if two hollow particulate parts are combined, they have a peanut-shell-like shape or a dumbbell-like shape. A plurality of such hollow particulate parts is combined to form the combined structure. The combined structure is a complex structure that does not have a definite form.

As described above, the carbon material is a combined structure (structure) in which a plurality of hollow particulate parts is combined in a bead-chain-like configuration. Structure is a term used to describe a complex structure of carbon black and refers to an agglomerate structure in which a plurality of primary particles of carbon black is combined with a plurality of branched points. In other words, the carbon material of the present invention can be likened to have a structure in which a primary particle of highly electrically conductive carbon black has a hollow interior, a shell (surrounding wall that constitutes a hollow particulate part in the carbon material) is composed of a plurality of carbon atoms with a graphene crystal structure, and interior spaces of agglomerates of the carbon black are in communication with each other. Therefore, the carbon material has high electrical conductivity and can stably ensure an electrolyte. The carbon material can significantly improve a battery property such as a rapid discharge property, a battery capacitive property, or a charge-discharge property of a lithium secondary battery.

When many hollow particulate parts are combined and thus the surface area of the combined structure is increased, the carbon material has increased electronic conductivity. When the overall complexity of the combined structure increases, in addition to the interior space of the combined structure, a gap surrounded by an exterior surface of the surrounding wall of the combined structure is also formed. In the case where the carbon material having such a combined structure is included in an electrode of a battery, an electrolyte enters the above-described space or gap. In other words, with a larger volume of the interior space or with a large volume of the gap surrounded by the surrounding wall of the combined structure, the carbon material will hold more electrolyte solution. The volume of the interior space and the volume of the gap surrounded by the surrounding wall of the combined structure in the carbon material can be compared with the volume of a conventionally used electrical conductive assistant using the below-described oil absorption as an indicator.

A lithium-containing transition metal oxide powder with a particle size distribution and low electronic conductivity is used as a positive electrode material for a lithium ion battery. In the prior art, an electron conduction path is established for a battery reaction by pressurizing and fixing, to a current collector, a mixture of an electrical conductive assistant composed of a carbon material that is assistant for electron conduction and a binder resin. A material other than the binder resin is in the form of powder particles, and an electrolyte solution exists in the spaces between the particles. Therefore, it was difficult for the prior art to actively dispose the electrolyte solution, in other words, lithium ions, in a proximity of a positive electrode material.

Thus far, carbon black with a complex shape has been widely used as an electrical conductive assistant. In contrast, the use of the carbon material according to an embodiment instead of such a conventionally used electrical conductive assistant allows an electrolyte solution to be held in the interior space of the hollow particulate part because the hollow particulate part of the combined structure possesses the interior space. The carbon material has a larger interior space than carbon black which has been conventionally used as an electrical conductive assistant. Therefore, the carbon material can simultaneously assist in supplying electrons and ions necessary for a battery reaction, thereby enabling a rapid battery reaction.

Furthermore, the state of a fine crystal structure of the carbon material can be analyzed by Raman spectroscopy. In a Raman spectrum obtained by Raman spectrometry of the carbon material, a peak in a proximity of a wavenumber of 1593 cm⁻¹ is called a G band indicating the sp2 bond (aromatic ring C═C stretching motion) of the carbon material. A peak in a proximity of a wavenumber of 1356 cm⁻¹ in the Raman spectrum is called a D band indicating the sp3 bond (C—H stretching motion) of the carbon material. When the sp2 bond is broken and the sp3 bond is formed, the D band increases. Also, a peak in a proximity of a wavenumber of 2680 cm⁻¹ in the Raman spectrum is called a 2D band indicating second-order phonon scattering (C—H stretching motion). The 2D band also indicates a number of surrounding walls, i.e., a number of graphene layers.

An intensity ratio (I_{G}/I_{2D}) of an intensity of a G band (I_{G}) to an intensity of a 2D band (I_{2D}) is considered to serve as an index indicating the laminated state of the graphene layers (D. Graf, et al., NANO LETTERS, 7, 238-242 (2007)). The article describes that there is one graphene layer when the intensity ratio (I_{G}/I_{2D}) is 0.2.

The intensity ratio (I_{G}/I_{2D}) of the intensity of the G band (I_{G}) to the intensity of the 2D band (I_{2D}) in a Raman spectrum of the carbon material obtained by Raman spectrometry is 0.40 or more, preferably 1.00 or more, more preferably 1.10 or more, even more preferably 1.20 or more, and particularly preferably 1.43 or more. The intensity ratio (I_{G}/I_{2D}) is 5.00 or less, and preferred in the order of 4.50 or less, 4.00 or less, 3.57 or less, 3.00 or less, 2.50 or less, and 2.08 or less.

When the intensity ratio (I_{G}/I_{2D}) of the carbon material falls within the above range, the strength property and the elastic deformability of the carbon material for maintaining the hollow structure are highly balanced. Furthermore, when the carbon material is used as an electrical conductive assistant of a lithium ion battery, it can improve battery properties such as a rapid discharge property, a capacitive property, and durability of the lithium ion battery. When the intensity ratio (I_{G}/I_{2D}) of the carbon material is less than 0.40, the graphene crystal structure is insufficiently formed. This decreases electronic conductivity, resulting in a lower discharge capacity. When the intensity ratio (I_{G}/I_{2D}) of the carbon material is more than 5.00, the number of graphene layers excessively increases, and thus the carbon material is less flexible. This decreases the electrode density, resulting in a lower battery charge capacity.

An oil absorption of the carbon material in accordance with JIS K5101-13-1:2004 (Pigment test method—Part 13: Oil absorption—Section 1: Refined linseed oil method) is 400 mL/100 g or more, preferably 600 mL/100 g or more, more preferably 800 mL/100 g or more, even more preferably 1000 mL/100 g or more, and particularly preferably 1400 mL/100 g or more. When the oil absorption of the carbon material falls within the above range, the battery property such as a 2C maintenance rate can be improved. The upper limit of the oil absorption of the carbon material is not particularly limited and is, for example, preferred in the order of 5000 mL/100 g or less, 4000 mL/100 g or less, 3500 mL/100 g or less, 3000 mL/100 g or less, and 2500 mL/100 g or less.

The carbon material can hold a large amount of an electrolyte solution because the carbon material can hold the electrolyte solution in the interior space of the combined structure and in the gaps enclosed by the outer surface of the surrounding wall of the combined structure. Therefore, since the oil absorption of the carbon material is much higher than that of carbon black which is commonly used as an electrical conductive assistant for a lithium ion battery, it can provide a stable supply of lithium ions and contribute to improving the battery properties such as a rapid charge property, a charge-discharge property, and a battery capacity of a lithium ion battery. On the other hand, the oil absorption of the carbon material of less than 400 mL/100 g decreases an amount of an electrolyte solution to be held, resulting in a delay in supplying ions upon a rapid reaction, and thus a lower discharge capacity. An excessively high oil absorption of the carbon material may make it difficult to maintain the structure of the carbon material and to control the amount of an electrolyte solution to be held.

Furthermore, an intensity ratio (I_{D}/I_{G}) of the intensity of the D band (I_{D}) to the intensity of the G band (I_{G}) in the Raman spectrum of the carbon material obtained by Raman spectrometry is preferably 0.1 or more and 10.0 or less, more preferably 0.5 or more and 5.0 or less, even more preferably 1.0 or more and 3.0 or less, particularly preferably 1.2 or more and 2.5 or less, and most preferably 1.4 or more and 2.0 or less. When the intensity ratio (I_{D}/I_{G}) of the carbon material falls within the above range, the sp2 orbital and the sp3 orbital in the carbon material become more favorable, and the electron conduction path and the ion conduction path are highly balanced. Furthermore, when the carbon material is used as an electrical conductive assistant for a lithium ion battery, it can improve a rapid discharge property, a capacity property, and a charge-discharge property of the lithium ion battery.

An interplanar distance d002 between (002) planes of the carbon material measured by an X-ray diffraction (XRD) method is preferably 3.0 Å or more and 5.0 Å or less, more preferably 3.3 Å or more and 4.5 Å or less, even more preferably 3.3 Å or more and 4.0 Å or less, particularly preferably 3.3 Å or more and 3.9 Å or less, and most preferably 3.3 Å or more and 3.8 Å or less.

A crystallite size Lc(002) in a c-axis direction of the carbon material measured by an X-ray diffraction method is preferably 0.10 nm or more and preferred in the order of 0.30 nm or more, 0.50 nm or more, 1.00 nm or more, and 1.10 nm or more. An upper limit of the crystallite size Lc(002) in the c-axis direction is preferably 20.00 nm or less, and preferred in the order of 5.00 nm or less, 3.00 nm or less, 2.50 nm or less, 2.00 nm or less, 1.90 nm or less, 1.50 nm or less, 1.25 nm or less, and 1.21 nm or less. When the Lc(002) which indicates a degree of crystallinity of the carbon material falls within the above range, the combined structure tends to have mesopores or macropores.

A lower limit of a crystallite size La(10) in an a-axis direction on a (10) plane of the carbon material measured by an X-ray diffraction method is preferably 0.1 nm or more, and preferred in the order of 0.5 nm or more, 1.0 nm or more, 1.5 nm or more, and 1.8 nm or more. An upper limit of the La(10) is preferably 10.0 nm or less, and preferred in the order of 5.0 nm or less, 4.5 nm or less, 4.0 nm or less, and 3.8 nm or less.

The BET specific surface area of the carbon material is a specific surface area calculated from nitrogen adsorption as specified in JIS Z8830, and is preferably 100 m²/g or more and 2700 m²/g or less, and preferred in the order of 300 m²/g or more and 2500 m²/g or less, 500 m²/g or more and 2000 m²/g or less, 600 m²/g or more and 1800 m²/g or less, and 800 m²/g or more and 1200 m²/g or less. When the BET specific surface area of the carbon material falls within the above range, the electrical conductivity and the oil absorption of the carbon material are further improved.

A total pore volume of the carbon material is preferably 0.10 cc/g or more, and preferred in the order of 1.00 cc/g or more, 1.50 cc/g or more, 2.00 cc/g or more, and 2.95 cc/g or more as measured by nitrogen adsorption/desorption measurement. An upper limit of the total pore volume of the carbon material is preferably 20.00 cc/g or less, and preferred in the order of 15.00 cc/g or less, 10.00 cc/g or less, 8.00 cc/g or less, 7.00 cc/g or less, 6.10 cc/g or less, and 5.70 cc/g or less.

When the total pore volume of the carbon material is 20.00 cc/g or less, the strength of the combined structure is improved and a shape of the hollow particulate part is well maintained. When the total pore volume of the carbon material is 0.10 cc/g or more, the amount of an electrolyte solution to be held in the hollow particulate part tends to increase. Thus, when the total pore volume of the carbon material falls within the above range, the hollow particulate part has favorable strength, contributing to stability of the hollow particulate part and maintaining the shape of the hollow particulate part well. Therefore, the carbon material can maintain a good balance between the electronic conductivity and the supply of ions to be held in the pores.

The micropore volume of the carbon material refers to a volume of pores having a pore size of less than 2 nm, and is preferably 5.00 cc/g or less and preferred in the order of 2.00 cc/g or less, 1.00 cc/g or less, 0.50 cc/g or less, and 0.40 cc/g or less. The lower limit of the micropore volume of the carbon material is preferably 0.01 cc/g or more, and preferred in the order of 0.05 cc/g or more, 0.10 cc/g or more, 0.20 cc/g or more, and 0.30 cc/g or more. When the micropore volume of the carbon material is 5.00 cc/g or less, the ionic conductivity is further improved, and when the micropore volume of the carbon material is 0.01 cc/g or more, the strength property of the carbon material is further improved.

The ratio of the micropore volume to the total pore volume of the carbon material is preferably 20% or less, and preferred in the order of 15% or less, 12% or less, 10% or less, and 9% or less. The lower limit of the ratio of the micropore volume of the carbon material is preferably 5% or more. If the ratio of the micropore volume is excessively small, the ionic conductivity tends to be inferior. Conversely, if the ratio is excessively large, the strength property of the carbonaceous material tends to be inferior.

The mesopore volume of the carbon material refers to a volume of pores having a pore size of 2 nm or more and 50 nm or less, and is preferably 0.1 cc/g or more and preferred in the order of 0.5 cc/g or more, 1.0 cc/g or more, 1.5 cc/g or more, and 2.0 cc/g or more. An upper limit of the mesopore volume of the carbon material is preferably 15.0 cc/g or less, and preferred in the order of 10.0 cc/g or less, 5.0 cc/g or less, 4.0 cc/g or less, and 3.5 cc/g or less. When the mesopore volume of the carbon material falls within the above range, the ionic conductivity and the strength property of the carbon material are more highly balanced.

The ratio of the mesopore volume to the total pore volume of the carbon material is preferably 10% or more, and preferred in the order of 20% or more, 30% or more, 40% or more, and 50% or more. The upper limit of the ratio of the mesopore volume of the carbon material is preferably 90% or less, and preferred in the order of 85% or less, 80% or less, 75% or less, and 70% or less. When the mesopore volume of the carbon material falls within the above range, the hollow particulate part has favorable strength, contributing to the stability of the hollow particulate part and maintaining the shape of the hollow particulate part well. Therefore, the carbon material can maintain a good balance between the electronic conductivity and the supply of ions to be held in the pores.

The macropore volume of the carbon material refers to a volume of pores having a pore size of more than 50 nm, and is preferably 0.01 cc/g or more and preferred in the order of 0.05 cc/g or more, 0.10 cc/g or more, 0.48 cc/g or more, and 1.00 cc/g or more. The upper limit of the macropore volume of the carbon material is preferably 15.00 cc/g or less, and preferred in the order of 10.00 cc/g or less, 5.00 cc/g or less, 3.00 cc/g or less, and 2.57 cc/g or less. When the macropore volume of the carbon material falls within the above range, the hollow particulate part has favorable strength, contributing to the stability of the hollow particulate part and maintaining the shape of the hollow particulate part well. Therefore, the carbon material can maintain a good balance between the electronic conductivity and the supply of ions to be held in the pores.

The ratio of the macropore volume to the total pore volume of the carbon material is preferably 5% or more, and preferred in the order of 10% or more, 15% or more, 20% or more, and 25% or more. The upper limit of the ratio of the macropore volume of the carbon material is preferably 80% or less, and preferred in the order of 70% or less, 60% or less, 50% or less, and 45% or less. When the ratio of the macropore volume of the carbon material is 5% or more, the ionic conductivity of the carbon material is further improved, and when the ratio of the macropore volume of the carbon material is 80% or less, the strength property of the carbon material is further improved.

A mode pore size (M) in a pore size distribution of the carbon material refers to a peak top value in a pore size distribution curve and is preferably 1 nm or more and 500 nm or less, and preferred in the order of 5 nm or more and 100 nm or less, 10 nm or more and 50 nm or less, 15 nm or more and 40 nm or less, and 15 nm or more and 30 nm or less. When the mode pore size of the carbon material falls within the above range, the oil absorption is further improved and the high level of the ionic conductivity and the electronic conductivity can be achieved.

Furthermore, an average pore size of the carbon material is preferably 1 nm or more and 500 nm or less, and preferred in the order of 5 nm or more and 100 nm or less, 10 nm or more and 75 nm or less, 15 nm or more and 50 nm or less, and 20 nm or more and 40 nm or less. When the average pore size of the carbon material falls within the above range, the oil absorption is further improved and the high level of the ionic conductivity and the electronic conductivity can be achieved.

A volume-based particle size distribution curve of the carbon material measured by a laser diffraction scattering method is obtained by measuring after the un-pulverized carbon material is immersed in a solvent for 9 minutes, and shows a difference in agglomeration force of the combined structure.

A D50 obtained from a volume-based particle size distribution curve measured by a laser diffraction scattering method refers to a particle size at which a percentage of particles having a particle size of D50 or less is 50%, and is preferably 1 μm or more and 100 μm or less, and is preferred in the order of 5 μm or more and 90 μm or less, 10 μm or more and 80 μm or less, 15 μm or more and 60 μm or less, 20 μm or more and 50 μm or less, 25 μm or more and 45 μm or less, and 30 μm or more and 40 μm or less. When the D50 of the carbon material falls within the above range, the electronic conductivity and the ionic conductivity of the carbon material are further improved.

A D10 obtained from the particle size distribution curve refers to a particle size at which a percentage of particles having a particle size of D10 or less is 10%, and is preferably 0.1 μm or more and 100.0 μm or less, and is preferred in the order of 0.5 μm or more and 50.0 μm or less, 1.0 μm or more and 50.0 μm or less, 5.0 μm or more and 30.0 μm or less, and 10.0 μm or more and 15.0 μm or less.

A D90 obtained from the particle size distribution curve refers to a particle size at which a percentage of particles having a particle size of D90 or less is 90%, and is preferably 5 μm or more and 250 μm or less, and is preferred in the order of 10 μm or more and 150 μm or less, 20 μm or more and 100 μm or less, 30 μm or more and 70 μm or less, 40 μm or more and 60 μm or less, 45 μm or more and 65 μm or less, and 45 μm or more and 55 μm or less. When the D90 of the carbon material falls within the above range, the electrical conductivity of the carbon material is further improved.

A ratio (D90/D10) of the D90 to the D10 of the carbon material obtained from the particle size distribution curve is preferably 100 or less and preferred in the order of 50 or less, 10 or less, and 5 or less. When the ratio (D90/D10) of the carbon material is 100 or less, the dispersibility of the carbon material is further improved and the electrical conductivity of a lithium ion battery is further improved.

A value (D90/M×1000) obtained by dividing a ratio (D90/M) of the D90 of the carbon material obtained from the particle size distribution curve to the mode pore size M of the carbon material by 1000 is preferably 50 or less, and is preferred in the order of 20 or less, 10 or less, 6 or less, and 4 or less. When the (D90/M×1000) is 50 or less, the dispersibility of the carbon material is further improved and the electrical conductivity of a lithium ion battery is further improved.

A carbon material to be contained in an electrode that a lithium ion battery includes has preferably high electrical conductivity. Since electron transfer in carbon is caused by transfer of π electrons, formation of an ideal electrically conductive path in the electrode by the carbon material requires a network arrangement of single-layer graphene with carbon atoms bonded in a planar direction. When a non-electrically conductive material such as a positive electrode material is filled with an electrically conductive material such as a carbon material, a small filling ratio of the electrically conductive material does not achieve electrical conductivity. Once the electrically conductive material reaches a certain filling ratio, a path of the electrically conductive material is formed in a compound to thereby rapidly increase electronic conductivity, after which the electronic conductivity becomes constant. The lower a threshold of such a filling ratio at which the electronic conductivity increases rapidly, the more suitable the carbon material will be as an electrically conductive material. Therefore, it is believed that the carbon material exhibits high electrical conductivity due to a highly balanced in-plane electrical conductivity and path-forming electrical conductivity, by combining a plurality of hollow particulate parts each having the surrounding wall that has a graphene structure and extends in a plane direction.

The electrical conductivity of the carbon material can be determined by measuring the electrical conductivity of powder by side-constrained uniaxial compression as described below. A cylindrical container composed of an insulating cylinder and a negative electrode is filled with the dried carbon material. A positive electrode is inserted into the insulating cylindrical container which has been filled with the carbon material so that the carbon material is placed between the negative electrode and the positive electrode and the cylindrical container is mounted on a force gauge stand. A spring-loaded force gauge installed in the force gauge stand is lowered to apply a force to and compress the carbon material in the cylindrical container. While measuring the force to compress and a height of the carbon material with a length measuring device, a value of resistance of the carbon material is measured with a digital multimeter connected to the positive electrode and the negative electrode. The electrical conductivity of the powdery carbon material during compression is calculated from the resulting value of resistance and the filling cross-section area and the filling height of the carbon material.

The electrical conductivity of the carbon material at a pressure of 10 MPa is preferably 1 S/cm or more and 100 S/cm or less, and is preferred in the order of 5 S/cm or more and 70 S/cm or less, 10 S/cm or more and 50 S/cm or less, and 20 S/cm or more and 30 S/cm or less. Note that the electrical conductivity of the carbon material is determined as a reciprocal of its electrical resistivity. The electrical resistivity of the carbon material can be measured in accordance with JIS K1469.

An apparent density of the carbon material is preferably 2.00 g/cc or less, and preferred in the order of 1.50 g/cc or less, 1.00 g/cc or less, 0.50 g/cc or less, and 0.30 g/cc or less. A lower limit of the apparent density of the carbon material is preferred in the order of 0.05 g/cc or more, 0.10 g/cc or more, and 0.15 g/cc or more. When the apparent density of the carbon material falls within the above range, the hollow structure in the carbon material is maintained and the carbon material can be suitably used as a material for a battery.

The apparent density of the carbon material can be calculated from Expression (1) below using the total pore volume and the true density. Note that the total pore volume (cc/g) is calculated by use of a value calculated from P/P0=0.99, and the true density is calculated by use of a graphite value 2.2 g/cc.

$$Apparent density ( g / cc ) = 1 / ( Total pore volume + ( 1 / True density ) ) \qquad Expression ( 1 )$$

The bulk density of the carbon material is preferably 0.01 g/L or more and 1000.00 g/L or less, and is preferred in the order of 0.10 g/L or more and 100.00 g/L or less, 0.50 g/L or more and 50.00 g/L or less, and 1.00 g/L or more and 25.00 g/L or less. When the bulk density of the carbon material falls within the above range, the electrical conductivity of the carbon material is further increased and an electrolyte solution can easily permeate the carbon material. Note that the bulk density refers to a mass per unit volume indicated by the carbon material filled in a container with a certain volume under a certain condition. The bulk density can be measured in accordance with JIS K6219-2.

The number density of the carbon material refers to a value calculated by the below-described method and is preferably 5×10¹⁴ pieces/g or more and 1×10²⁰ pieces/g or less, and is preferred in the order of 1×10¹⁶ pieces/g or more and 1×10¹⁹ pieces/g or less, 5×10¹⁶ pieces/g or more and 5×10¹⁸ pieces/g or less, 1×10¹⁷ pieces/g or more and 1×10¹⁸ pieces/g or less, and 3×10¹⁷ pieces/g or more and 7×10¹⁷ pieces/g or less. When the number density of the carbon material falls within the above range, the oil absorption of the carbon material is further improved.

The number density P (pieces/g) of the carbon material can be calculated from Expression (2) below based on a volume V (m³) per one primary particle and a carbon density ρ (g/m³). Here, the true density of graphite, 2.2 g/cc, is used as the carbon density ρ. The volume V (m³) can be calculated from Expression (3) below.

$$Number density P = 1 / ( V \times ρ ) \qquad Expression ( 2 )$$

$$Volume V = π \times {( {D}_{1} - {D}_{0} )}^{3} / 6 \qquad Expression ( 3 )$$

Herein, D₀ is an inner diameter of a primary particle and D₁ is an outer diameter of a primary particle. The D₀ may be a mode pore size as described above. The D₁ may be determined by multiplying the D₀ by an average number n of layers and the interplanar distance d002 between the (002) planes, doubling the resulting value, and then adding the doubled value to the mode pore size. The D₁ may also be determined by TEM image analysis, etc. Although not a carbon material according to an embodiment, for example, DENKA BLACK Li-100, which is a known material, can be calculated taking the particle outer diameter (D₁) as an average particle diameter of 35 nm and the D₀ as 0.

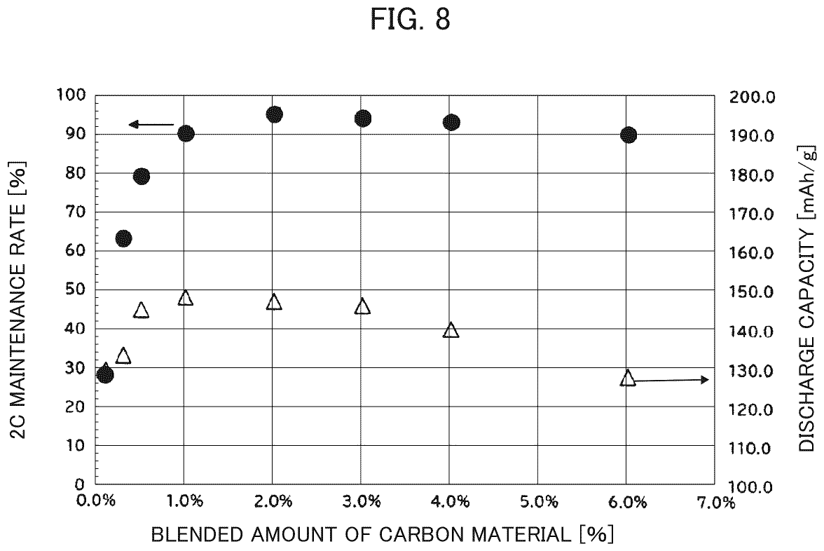

The carbon content of the carbon material can be determined by the temperature programmed desorption mass spectrometry (TPD-MS) shown in FIG. 8 below, and is preferably 95.0% or more and preferred in the order of 97.0% or more, 98.0% or more, 99.0% or more, and 99.3% or more.

The oxygen content of the carbon material is calculated from an H₂O release amount, a CO release amount, and a CO₂ release amount determined by the temperature programmed desorption mass spectrometry, and is preferably 5.0% or less, and is preferred in the order of 3.0% or less, 2.0% or less, 1.0% or less, and 0.6% or less. When the oxygen content of the carbon material falls within the above range, the stability of a lithium ion battery is further improved, further contributing to higher performance of the lithium ion battery.

For higher performance and longer service life of a lithium ion battery, a highly efficient battery reaction without decreasing efficiency due to side reactions is required, and the carbon material in an electrode requires electrochemical stability, i.e., oxidation resistance and corrosion resistance. Side reactions such as oxidation that occur electrochemically are considered to start from an oxygen-containing functional group or an edge surface of the carbon material. To improve the oxidation resistance of the carbon material, it is effective to decrease the edge surface with low oxidation resistance as well as the oxygen-containing functional group.

The amounts of H₂, H₂O, CO, and CO₂ released from the carbon material are measured by temperature programmed desorption mass spectroscopy for measuring the oxygen content of the carbon material, and these gases are derived from an oxygen-containing functional group such as a hydroxyl group (including a phenol group), a carbonyl group (including a quinone), an ether, an acid anhydride, a carboxyl group, and a lactone at an edge end of the carbon material. Therefore, a large amount of oxygen-containing functional groups in the carbon material indicates a large amount of oxygen-containing functional groups or edges present in the structure of the carbon material. The amounts of oxygen-containing functional groups or edges of the carbon material can be adjusted by the CVD conditions or the temperature during a heat treatment as described below.

The ratio (O/C) of the oxygen content to the carbon content of the carbon material is preferably 1.00 or less, and is preferred in the order of 0.50 or less, 0.10 or less, 0.05 or less, and 0.01 or less. When the ratio (O/C) of the carbon material falls within the above range, it can further contribute to longer service life and higher performance of a lithium ion battery.

The amount of the gases of the carbon material measured by temperature programmed desorption mass spectroscopy is preferably 5000 μmol/g or less, and are preferred in the order of 3000 μmol/g or less, 1000 μmol/g or less, 750 μmol/g or less, and 500 μmol/g or less. When the amount of the gases of the carbon material falls within the above range, it can further contribute to longer service life and higher performance of a lithium ion battery.

The amount of the edge of the carbon material calculated from the amounts of the gases measured by temperature programmed desorption mass spectroscopy is preferably 500 m²/g or less, and is preferred in the order of 300 m²/g or less, 100 m²/g or less, 50 m²/g or less, and 30 m²/g or less. The amount of the edge of the carbon material is preferred in the order of 750 μmol/g or less and 500 μmol/g or less. When the amount of the edge of the carbon material falls within the above range, the durability is further improved, further contributing to stability and higher performance of a lithium ion battery.

The ash content of the carbon material is preferably 10000 ppm or less, and preferred in the order of 5000 ppm or less, 4000 ppm or less, 3500 ppm or less, and 3000 ppm or less. When the ash content of the carbon material falls within the above range, the stability of an electrolyte solution is further improved, further enhancing durability and performance of a lithium ion battery.

The pH of the carbon material is preferably 5.0 or more and 10.0 or less, and is preferred in the order of 5.5 or more and 9.5 or less, 6.0 or more and 9.0 or less, 6.5 or more and 8.5 or less, and 7.0 or more and 8.0 or less. When the pH of the carbon material falls within the above range, the stability is further improved.

A combustion temperature of the carbon material is preferably 300° C. or more and preferred in the order of 400° C. or more, 450° C. or more, 500° C. or more, 550° C. or more, and 600° C. or more. A test for the combustion temperature of the carbon material is performed as a simple test for corrosion resistance. When the combustion temperature of the carbon materials is 300° C. or more, the electrochemical stability in an electrode is considered good.

The carbon material is also excellent in electron transfer since the carbon material includes graphene. Therefore, the carbon material can function to assist a battery reaction of a lithium ion battery when included in an electrode of the lithium ion battery. The carbon material is excellent in supplying ions during a reaction since the carbon material has the combined structure in which a plurality of hollow particulate parts is combined in a bead-chain-like configuration and the hollow particulate parts each include the surrounding wall with a plurality of pores and the combined structure includes the interior space of the hollow particulate part, and thus an electrolyte solution in which lithium ions are dissolved can permeate and be held in the combined structure. Therefore, the carbon material is suitable as a material for a secondary battery because the carbon material can suitably assist a secondary battery reaction.

Such a carbon material is suitably used for a dispersion liquid, a composition for an electrode, a slurry for an electrode, an electrode, and a lithium ion battery because the carbon material has a graphene crystal structure, graphene layers is controlled in a predetermined laminated state, and the carbon material has a high oil absorption. In addition, the physical property of the carbon material of the present invention makes it possible for the carbon material to be used in new technologies in addition to the current electrolyte solution and electrode systems that have conventionally been used.

The carbon material can be effectively used and express its functionality in any electrochemical device in addition to a lithium ion battery. Specifically, the carbon material functions as an electrically conductive path in an electrode when a device reaction involves donation and acceptance of electrons, an reinforcement when an electrode or the like is physically deformed, and an prevention of direct contact between a third material (e.g., catalyst) and a reacting material by taking advantage of the durability of the graphene crystal structure when the reacting material is in an oxidized state or a reduced state.

Suitable examples of a device for which the carbon material can be used include a non-aqueous electrolyte liquid battery such as a lithium ion battery, a sodium ion battery, a potassium ion battery, a magnesium ion battery, a calcium ion battery, an aluminum ion battery, a lithium sulfur battery, or a lithium air battery; an inorganic solid electrolyte battery such as a sulfide-based solid electrolyte or an oxide-based solid electrolyte; a polymer solid electrolyte battery such as a polyethylene oxide-based battery; a semi-solid battery represented by a polymer gel electrolyte battery containing an electrolyte solution such as PVDF, etc.

For these devices, easily graphitizable carbon, hardly graphitizable carbon, graphite, a lithium alloy-based material such as silicon or tin, and other metallic materials such as lithium are used as a negative electrode active material, and a lithium-containing metal oxide, in particular, a lithium-containing transition metal oxide having a layered, spinel, or olivine structure, a lithium-free metal oxide, an organic positive electrode material, a charge transfer complex-based positive electrode material, sulfur, or a fluoride-based material is used as a positive electrode active material. The carbon material according to the embodiment can be suitably applied to any of the above-described active materials to effectively enhance the electrical conductivity. The carbon material is also suitable as a material for a lithium-sulfur battery described in WO2018/225619, Japanese Unexamined Patent Application Publication Nos. 2023-501679, 2019-517116, and 2022-191280, etc.

The carbon material can also be suitably used for an organic electrolyte solution capacitor, an aqueous electrolyte solution capacitor, or an aqueous solution battery. Regarding fuel cells, the carbon material can be used in a PEFC, a SOFC, or a DMPC, especially as a support for an oxidation-reduction catalyst in addition to imparting electrical conductivity in an electrode.

For an electrolyte solution, the carbon material can also suitably be applied for a battery using a gel polymer electrolyte composed of a gel polymer in which a polymer is gelled by an organic solvent and which includes a Li salt as the electrolyte or a semi-solid electrolyte, etc., a dry electrode battery that can shorten a battery manufacturing process, or a clay electrode battery that can realize a thick electrode.

Conventionally, for a gel electrolyte battery which is a semi-solid electrolyte battery, a battery of which a battery element is housed in a cylindrical or prismatic metal case has been predominant, but a gel electrolyte battery using an aluminum laminated film as an outer packaging material has been considered to reduce the weight and thickness. The gel electrolyte battery can be prevented from swelling even with a weak outer packaging material by swelling a polymer such as PVDF with an electrolyte solution to suppress vapor pressure.

Several types of large-scale specialized equipment are generally required for producing an electrode in a battery manufacturing process, and the capital investment for, for example, a coating apparatus or a drying apparatus and the cost for solvent recovery of a slurry for an electrode may increase. Moreover, for a higher battery capacity, a thicker electrode is required to raise the electrode capacity density. The clay (clay-like) electrode is well-suited to accomplish such tasks. For the clay electrode battery, an electrode composition that is mixed using an electrolyte solution instead of a solvent (NMP) for a slurry for an electrode is clay-like, which is applied directly to a current collector and then assembled directly into a battery, thereby achieving both a lower production cost and a higher capacity.

For a dry electrode, in order to improve the efficiency of the electrode manufacturing process as described above, a powder of a mixed dry positive electrode composition of an active material, an electrically conductive agent, and a binder is produced in advance without using a liquid slurry as in the past, and a thin film is directly formed on a current collector while the powder is pressurized, and the resulting thin film is pressurized by a roll press, etc. to form an electrode.

The carbon material can also be used for other applications than an electrochemical device. Suitable examples of the other applications include an electronic device application such as a sensor using graphene, an electromagnetic interference suppression material, an antenna module, a heat dissipation substrate, a heat exchange device, a separation membrane, a reverse osmosis membrane, a transparent electrode material, a structural material application utilizing mechanical flexibility, an electrically conductive ink, a paste, etc. In addition, with the demand for a lighter car body which is directly linked to reduced carbon dioxide emissions and energy savings, the carbon material is suitably used as a reinforcement for various rubbers including tires, a paint, a coloring pigment, an electrically conductive filler for various polymers, an additive for a magnetic recording medium, as applications that lead to weight reduction by utilizing the hollow shape of the combined structure, etc.

### (Method for Producing Carbon Material)

Next, a method for producing a carbon material according to an embodiment will be described.

The method for producing a carbon material according to an embodiment includes a removal step in which a template material is removed from a carbon material precursor to thereby obtain a carbon material, the carbon material precursor including the template material that is an agglomerate of a plurality of primary particles agglomerated in a bead-chain-like configuration and a carbonaceous layer that covers a surface of the template material.

As described above, the method for producing a carbon material according to an embodiment includes the removal step and can produce the carbon material according to the embodiment.

In the removal step, the template material is removed from the carbon material precursor in which a surface of the template material is covered with a carbonaceous layer. Thus, the carbon material can be obtained.

The carbonaceous layer covers the entire surface of the template material. The template material to be removed in the removal step is an agglomerate of a plurality of primary particles agglomerated in a bead-chain-like configuration. The primary particles constituting the agglomerate are preferably primary nanoparticles each having a particle size on the order of nanometers. The agglomerate has an extended shape.

The template material preferably has a branched part where the agglomerate is branched. If the template material has such a branched part, the resulting carbon material will have a branched part. For the template material, the agglomerate preferably has one or more ring-shaped parts. If the template material has such a ring-shaped part, the resulting carbon material will have a ring-shaped part. For example, one end of the agglomerate may be combined to the other end of the agglomerate to form a ring-shaped part, tips of branches extending from a branched part may be combined to each other to form a ring-shaped part, or a ring-shaped part may be formed at a part other than ends of the agglomerate.

The particle size of the primary particles constituting the template material is 1 nm or more and 150 nm or less, preferably 5 nm or more and 100 nm or less, more preferably 10 nm or more and 60 nm or less, even more preferably 15 nm or more and 50 nm or less, and particularly preferably 20 nm or more and 40 nm or less. When the particle size of the primary particles falls within the above range, the oil absorption and the mesopore volume of the resulting carbon material can be further increased. Further, the template material is easily handled. Furthermore, permeability of a raw material gas serving as a carbon source of the carbonaceous layer to be formed on the surface of the template material is better, which facilitates uniform coverage of the surface of the template material by the carbonaceous layer.

The BET specific surface area of the template material is preferably 1 m²/g or more and 1000 m²/g or less, more preferably 10 m²/g or more and 500 m²/g or less, even more preferably 20 m²/g or more and 200 m²/g or less, particularly preferably 40 m²/g or more and 160 m²/g or less, and most preferably 50 m²/g or more and 120 m²/g or less. When the BET specific surface area of the template material falls within the above range, the oil absorption and the mesopore volume of the resulting carbon material can be further increased.

The specific surface area of the resulting carbon material depends on a specific surface area of the template material. A ratio of volume to surface area of a particle increases as the particle size decreases, so the surface area per volume, that is, the surface area per unit mass increases as a particle size decreases. Therefore, the carbon material with a high specific surface area can be obtained by using an agglomerate in which nanoparticles each having a small primary particle size are combined.

The average particle size of the primary particles constituting the template material is preferably 1 nm or more and 100 nm or less, and is preferred in the order of 2 nm or more and 50 nm or less, 4 nm or more and 50 nm or less, and 3 nm or more and 30 nm or less. The length of the agglomerate is preferably 0.01 μm or more and 100.00 μm or less, more preferably 0.05 μm or more and 10.00 μm or less, and even more preferably 0.10 μm or more and 5.00 μm or less. The average particle size of the agglomerate is preferably 0.05 μm or more and 100.00 μm or less and more preferably 0.10 μm or more and 5.00 μm or less.

The bulk density of the template material is preferably 0.1 g/L or more and 500.0 g/L or less, more preferably 0.5 g/L or more and 250.0 g/L or less, even more preferably 1.0 g/L or more and 200.0 g/L or less, particularly preferably 10.0 g/L or more and 100.0 g/L or less, and most preferably 30.0 g/L or more and 70.0 g/L or less. When the bulk density of the template material falls within the above range, the electrical conductivity, the oil absorption, and the mesopore volume of the resulting carbon material can be further increased.

The template material is preferably basic or acidic. Magnesium oxide or calcium carbonate is suitable as a basic template material. Aluminum oxide or a silica compound with a silanol is suitable as an acidic template material. An acidic pH is defined as a value of a 4% aqueous solution and is 7.0 or less, preferably 6.5 or less, more preferably 6.0 or less, even more preferably 5.5 or less, and particularly preferably 5.0 or less. The acidic pH is preferably 1.0 or more, more preferably 2.0 or more, even more preferably 3.0 or more, particularly preferably 3.5 or more, and most preferably 4.0 or more.

The carbon content of the template material is preferably 0.0001% by weight or more, more preferably 0.0100% by weight or more, even more preferably 0.0500% by weight or more, particularly preferably 0.100% by weight or more, and most preferably 0.500% by weight or more. The upper limit of the carbon content of the template material is preferably 5.0000% by weight or less, more preferably 4.0000% by weight or less, even more preferably 3.0000% by weight or less, particularly preferably 2.5000% by weight or less, and most preferably 2.0000% by weight or less. When the carbon content of the template material falls within the above range, formation of the carbonaceous layer on the surface of the template is facilitated.

The template material is preferably a compound that catalyzes a carbon deposition reaction. Such a compound is preferably a non-metallic compound, a metalloid (semi-metallic) compound, or a metallic compound, and more preferably a metalloid compound or a metallic compound.

A ceramic compound (non-metallic inorganic solid material) is suitable as the non-metallic compound. Glass, cement, or a fine ceramic is suitable as the ceramic.

The metalloid compound is preferably a boron compound, a silicon compound, a germanium compound, or an antimony compound, and more preferably a silicon compound. The silicon compound is preferably silicon monoxide, silicon dioxide, silicon nitride, silicon carbide, or silicon, and more preferably silicon dioxide.

The metallic compound is preferably a monovalent metallic compound or a polyvalent metallic compound, and more preferably a polyvalent metallic compound. The monovalent metallic compound is suitably a chloride, a sulfate, a nitrate, a phosphate, or a carbonate of an alkali metal such as sodium or potassium. The polyvalent metallic compound is preferably an alkaline earth metallic compound of calcium, magnesium or the like, or a trivalent metallic compound of aluminum or the like, and more preferably a calcium compound, a magnesium compound, or an aluminum compound. The calcium compound is preferably a chloride, a sulfate, a nitrate, a phosphate, a carbonate, or an oxide, more preferably a carbonate or an oxide, and even more preferably an oxide. The magnesium compound is preferably a chloride, a sulfate, a nitrate, a phosphate, a carbonate, or an oxide, more preferably a carbonate or an oxide, and even more preferably an oxide. The aluminum compound is preferably a chloride, a sulfate, a nitrate, a phosphate, a carbonate, or an oxide, more preferably a carbonate or an oxide, and even more preferably an oxide.

A fumed compound can be suitably used as the template material because the fumed compound forms an agglomerate of a plurality of primary nanoparticles combined in a bead-chain-like configuration with a plurality of branched structures. The fumed compound is preferably a compound obtained by a flame hydrolysis method which is a type of dry production method for an inorganic material.

A fumed silicon dioxide is suitable as the fumed compound. The fumed silicon dioxide produced by the flame hydrolysis method does not undergo a liquid-phase process during its production, resulting in slow agglomeration. As a result, the fumed silicon dioxide has excellent dispersibility in a liquid phase or a compound (solid phase). The fumed silicon dioxide is produced, along with hydrochloric acid produced as a byproduct, by high-temperature gas-phase hydrolysis of silicon tetrachloride in oxyhydrogen flame. Production conditions such as the flame temperature, feed ratio of oxygen and hydrogen, feed amount of raw materials, and residence time can be changed to obtain silicon dioxide particles with an average particle size of 7 nm or more and 40 nm or less and a specific surface area of 50 m²/g or more and 380 m²/g or less.

The fumed compound produced by the flame hydrolysis method is suitably fumed alumina, fumed titania, or fumed zirconia, in addition to fumed silicon dioxide. Other fumed metallic compounds are suitably a chloride of Na, Ba, or Sr; a sulfate of K, Na, Sr, or Mg; a nitrate of Na or K; a phosphate of Na or K; a carbonate of Na, K, Ca or Mg; or a metal oxide of Na, K, Ca or Ba. The template material is preferably in the form of a fumed state.

Precipitated silica can also be used as the template material. The precipitated silica is obtained by reacting a sodium silicate solution with an acid in a liquid phase, followed by precipitation, filtration, washing, drying, and pulverizing. The reaction conditions can be adjusted to obtain silicon dioxide particles with an average particle size of 7 nm or more and 140 nm or less and a specific surface area of about 20 m²/g or more and 400 m²/g or less.

The water content of the template material is preferably 5.0% or less, more preferably 3.0% or less, even more preferably 1.5% or less, particularly preferably 1.0% or less, and most preferably 0.5% or less.

When the CVD method is used to form the carbonaceous layer on the surface of the template material, the amount of carbon to be deposited on the surface of the template material is affected by the CVD reaction conditions such as the type of raw material gas, concentration of the raw material gas, flow velocity, reaction temperature and reaction time, or the surface of the template material, especially the surface of the template material. The template material with a surface suitable for carbon deposition by the CVD method is a compound having an oxygen atom (oxygen-containing compound). In this case, carbon contained in the raw material gas is replaced by an oxygen atom in the oxygen-containing compound during the CVD reaction, from which carbonaceous matter is deposited. The oxygen-containing compound is preferably a metal oxide or a metal carbonate, and more preferably an acidic or basic compound. Magnesium oxide or calcium carbonate is suitable as a basic oxygen-containing compound.

The surface of the template material suitable for formation of the carbonaceous layer by the CVD method has suitably a hydrocarbon serving as a carbon source. The hydrocarbon is a compound that can be used as a raw material gas, suitably a compound having a methyl group or a carbon-carbon unsaturated bond. The template material is suitably an inorganic compound having a hydrocarbon on its surface.

The inorganic compound having a hydrocarbon on its surface is preferably an inorganic material whose surface is treated with a silane coupling agent, and more preferably a silica compound whose surface is treated with a silane coupling agent. The silane coupling agent may be those commonly used as a surface treatment agent without any limitation, and is preferably a methoxy-based silane coupling agent, an ethoxy-based silane coupling agent, a vinyl-based silane coupling agent, a dialkoxy-based silane coupling agent, or a trialkoxy-based silane coupling agent, more preferably a trialkoxy-based silane coupling agent with a large number of methyl groups per molecule, and even more preferably a trimethoxysilane compound.

The amount of the silane coupling agent is appropriately selected depending on the intended use, is expressed as an amount of hydrocarbon in an inorganic material, and is preferably 0.01% by weight or more and 10.00% by weight or less, more preferably 0.02% by weight or more and 8.00% by weight or less, even more preferably 0.05% by weight or more and 5.00% by weight or less, particularly preferably 0.10% by weight or more and 3.00% by weight or less, and most preferably 0.50% by weight or more and 1.50% by weight or less. When the amount of the silane coupling agent (amount of the hydrocarbon) in the inorganic material falls within the above range, the amount of the carbonaceous layer to be formed on the surface of the template material can be easily adjusted.

The template material may be used alone or two or more thereof may be used in combination.

In the removal step, the template material is removed by any method as long as it can remove the template material so as to leave the carbonaceous layer, preferably by dissolution with an acid or an alkali, and more preferably by dissolution with an acid.

The acid to be used to dissolve and remove the template material is appropriately selected depending on the type of template material, and is preferably hydrochloric acid, sulfuric acid, nitric acid, phosphoric acid, boric acid, or hydrofluoric acid, and more preferably hydrochloric acid or hydrofluoric acid. The concentration of the acid to be used to dissolve and remove the template material is appropriately adjusted to an extent that the template material can be dissolved and removed. Although the amount of the acid to be used is not particularly limited as long as it can dissolve and remove the template material, for example, the amount of the acid is 30 times or more or 50 times or more the stoichiometric ratio for the template material.

The temperature at which the template material is dissolved and removed is preferably 5° C. or more and 100° C. or less, more preferably 10° C. or more and 50° C. or less, and even more preferably 20° C. or more and 30° C. or less. The removal step may be performed along with stirring operation, vibration operation, or another operation. The time required for the removal step is appropriately selected to an extent that the template material can be removed.

After removal of the template material, the resulting carbonaceous layer can be collected, for example, by filtration, followed by washing with pure water. The washing conditions can be appropriately selected, and the washing is completed when the pH of the washed solution used for the carbonaceous layer is confirmed to be neutral.

After the washing, the resulting carbonaceous layer can be dried by vacuum heated drying, etc. The drying conditions of vacuum heated drying are not particularly limited, and it is suitable that the carbonaceous layer is dried by vacuum heated drying at a temperature of 100° C. or more and 200° C. or less for 1 hour or more and 10 hours or less.

It is also preferred that the method for producing the carbon material further comprises a heating step in which the carbon material is heated at a temperature of 1000° C. or more and 3000° C. or less after the removal step.

In the heating step that follows the removal step, the carbon material obtained in the removal step is heated. The heating temperature is 1000° C. or more and 3000° C. or less, preferably 1300° C. or more and 2500° C. or less, more preferably 1500° C. or more and 2000° C. or less, even more preferably 1600° C. or more and 1900° C. or less, and particularly preferably 1750° C. or more and 1850° C. or less.

The heating time (holding time at a predetermined heating temperature) in the heating step is preferably 0.1 hours or more and 10.0 hours or less, more preferably 0.2 hours or more and 5.0 hours or less, and even more preferably 0.5 hours or more and 5.0 hours or less. The ambient pressure in the heating step is preferably atmospheric pressure or a reduced pressure.

In the heating step, a functional group (mainly oxygen-containing functional group) that is bonded to a carbon constituting the carbon material and a carbon chain that does not form the six-membered ring is detached from the carbon material to form a dangling bond at a temperature of 1000° C. or more. When the thus-formed dangling bond bonds to another nearby carbon, the surface of the carbon material becomes difficult for a functional group to bond to the surface. Heat treatment at preferably 1500° C. or more and more preferably 1600° C. or more allows the carbon material to have the features such as further improved electronic conductivity and maintenance of the interior space.

Further, the heating step can control structural defects in the graphene and a non-graphene part that make up the surrounding wall of the carbon material. The structural defects include a space formed in the combined structure of the carbon material due to leaching of the template material and a penetration hole in the surrounding wall of the carbon material. The extent of the structural defects can be controlled by adjusting the conditions of the heating step such as the heating temperature or the heating time, that is, the size of the space inside the carbon material and the size of the penetration hole that allows an electrolyte solution to enter the carbon material can be controlled.

### (Carbon Material Precursor)

Next, a carbon material precursor according to an embodiment will be described.

The carbon material precursor according to the embodiment includes a template material composed of an agglomerate of a plurality of primary particles agglomerated in a bead-chain-like configuration, and a carbonaceous layer covering a surface of the template material and having a plurality of pores.

The carbon material precursor according to the embodiment has a template material and a carbonaceous layer covering a surface of the template material. The carbon material precursor is the carbon material precursor to be used in the removal step in the method for producing the carbon material according to the embodiment.

The template material of the carbon material precursor is an agglomerate of a plurality of primary particles agglomerated in a bead-chain-like configuration, and preferably has the same configuration as the template material constituting the carbon material precursor to be used in the method for producing the carbon material according to the embodiment.

The carbonaceous layer formed on the surface of the template material has a plurality of pores. The carbonaceous layer preferably covers the entire surface of the template material. The carbonaceous layer also preferably has a graphene crystal structure.

### (Method for Producing Carbon Material Precursor)

Next, a method for producing a carbon material precursor according to an embodiment will be described.

The method for producing a carbon material precursor according to the embodiment includes a coverage step in which a surface of a template material that is an agglomerate of a plurality of primary particles agglomerated in a bead-chain-like configuration is covered with a carbonaceous layer to obtain the carbon material precursor.

As described above, the method for producing a carbon material precursor according to the embodiment includes the coverage step and can produce the carbon material precursor according to the embodiment.

In the coverage step, the surface of the template material is covered with the carbonaceous layer to obtain the carbon material precursor. The template material is an agglomerate of a plurality of primary particles agglomerated in a bead-chain-like configuration, and preferably has the same configuration as the template material constituting the carbon material precursor according to the embodiment.

The carbonaceous layer can be formed on the surface of the template material by bringing the template material into contact with an organic matter serving as a carbon source and heat-treating it to carbonize. The template material may be brought into contact with the carbon source simultaneously with or separately from the carbonization heat treatment. The template material may be brought into contact with the carbon source preferably at room temperature (25° C.) or more and 1000° C. or less.

The number of carbonaceous layers is appropriately selected depending on the intended use and is preferably 1.0 or more, more preferably 1.2 or more, even more preferably 1.5 or more, particularly preferably 2.0 or more, and most preferably 2.2 or more. The upper limit of the number of carbonaceous layers is preferably 15.0 or less, more preferably 10.0 or less, even more preferably 8.0 or less, particularly preferably 6.0 or less, and most preferably 5.0 or less. When the number of carbonaceous layers falls within the above range, the carbon material obtained by heating the carbonaceous layer has an excellent strength property and an excellent elastic deformability, and the hollow structure of the hollow particulate part of the carbon material can be maintained well, thereby highly enhancing the properties of a lithium ion battery. The number of carbonaceous layers is a value calculated by forming the carbonaceous layer on the surface of the template material, calculating a weight of the carbonaceous layer using thermogravimetric analysis (TG), calculating the weight of the carbonaceous layer per area of the template material from the weight of the carbonaceous layer and the surface area of the template material, and dividing the resulting value by a weight per area of single-layer graphene (7.61×10⁻⁴ g/m²).

A method for bringing the carbon source into contact with the template material can be broadly classified into a liquid-phase contact method and a vapor-phase contact method, the vapor-phase contact method is preferred. The liquid-phase contact method is, for example, a method in which the template material is immersed in an organic solution. The vapor-phase contact method is, for example, a method in which an organic gas is introduced at a high temperature and brought into contact with the template material, the so-called CVD method.

For the liquid-phase contact method, an organic compound having a functional group present on the surface of the template material, specifically an organic compound having a functional group that can react with a hydroxyl group, in particular, a benzene series of hydrocarbon compounds having a functional group that can react with a hydroxyl group are preferably used. Among these, a benzene series of aromatic hydrocarbon compounds having at least one of a hydroxyl group or a carboxyl group is preferred, and phenol, hydronaphthalene or dihydronaphthalene is more preferred. The use of the organic compound having a functional group that can react with a functional group present on the surface of the template material results in a strong bond such as an ester bond between the template material and the organic compound, and thus the organic compound tends to be carbonized in situ without volatilizing during the carbonization heat treatment.

For the liquid-phase contact method, the template material is impregnated at room temperature with a solution in which an organic compound serving as a carbon source is dissolved in a solvent to bring the template material into contact with the organic matter serving as the carbon source. Then, the result is held at a temperature in a range of 250° C. or more and 600° C. or less for a certain time in order to strongly bond the organic matter with the template material. Thus, the hydroxyl group on the surface of the template material and the organic matter undergo a dehydration-condensation reaction such as an esterification reaction and are fixed by a bond such as an ester bond, facilitating formation of the carbonaceous layer with a graphene structure. The temperature is then lowered, and excess organic matter that has not reacted with the template material is removed by washing with a solvent, etc.

Heat treatment is then performed to carbonize the organic compound serving as a carbon source that has been in contact with the template material. This heat treatment causes a dehydrogenation reaction in the organic matter such as a hydrocarbon, allowing the structuring of graphene in the carbonaceous layer to further progress. The temperature of the heat treatment is preferably 600° C. or more and 1500° C. or less, more preferably 750° C. or more and 1500° C. or less, and even more preferably 800° C. or more and 1000° C. or less. Note that the heat treatment may be conducted at 1500° C. or more as long as the template material does not collapse or melt.

For the vapor-phase contact method, an organic compound serving as a carbon source is brought into contact with the template material. In order to strongly bond the carbon source with the template material, the chemical vapor deposition (CVD) method is preferably performed in a temperature range where a dehydrogenation reaction can proceed, specifically 400° C. or more and 1000° C. or less.

The organic compound to be used as the carbon source in the vapor-phase contact method may be appropriately selected depending on the intended use, and is suitably a hydrocarbon such as a saturated hydrocarbon, an unsaturated hydrocarbon having at least one of a double bond or a triple bond, an alicyclic hydrocarbon, or an aromatic hydrocarbon. The saturated hydrocarbon may be linear or branched, with methane, ethane, or propane being suitable. The unsaturated hydrocarbon may be linear or branched, with ethylene, propylene, isoprene, or acetylene being suitable. The alicyclic hydrocarbon is suitably cyclopropane or cyclohexane. The aromatic hydrocarbon is suitably benzene or toluene. Among these hydrocarbons, methane, ethane, acetylene, ethylene, propylene, or benzene is preferred and, from the viewpoint of depositing highly crystalline carbon, methane, propylene, or benzene is preferred. Methane is particularly suitable from the viewpoint of obtaining highly crystalline carbon with a high pyrolysis temperature.

In addition to the above-described substances, an alcohol such as methanol, ethanol, propanol or butanol, or a nitrogen-containing compound such as acetonitrile or acrylonitrile is suitable as the organic compound to be used in the vapor-phase contact method.

The reaction temperature of the CVD reaction is appropriately selected depending on the type of the template material and the decomposition temperature of the organic compound serving as the carbon source, and is preferably 400° C. or more and 1000° C. or less, more preferably 600° C. or more and 950° C. or less, and even more preferably 800° C. or more and 900° C. or less.

The reaction time (CVD treatment time at a predetermined heating temperature) in the CVD reaction is appropriately selected depending on the type of the template material and the organic compound serving as the carbon source, and the number of carbonaceous layers to be deposited, and is preferably 0.1 hours or more and 10.0 hours or less, more preferably 0.5 hours or more and 5.0 hours or less, and even more preferably 1.0 hour or more and 3.0 hours or less. The analytical method disclosed herein can be applied to analyze a product and, based on the results thereof, the time required for sufficient carbon deposition can be set as appropriate.

The CVD reaction may be performed under an inert gas atmosphere if necessary. The inert gas is preferably nitrogen, helium, neon, or argon, and more preferably argon. For the CVD method, carbon in the vapor phase can be easily adsorbed or deposited on the template material by heating a gaseous organic compound together with a carrier gas while they flow so as to bring them into contact with the template material. The type, the flow velocity, and the flow volume of the carrier gas as well as the heating temperature can be appropriately adjusted depending on the type of organic compound to be used. The carrier gas is, for example, the above-described inert gas, or may also be a mixture with the inert gas and an oxygen gas or a hydrogen gas.

The number of carbonaceous layers to be formed on the template material can be appropriately selected depending on the CVD reaction time. In order to form a small number of carbonaceous layers, the flow velocity of the carrier gas is preferably 0.05 m/min or more and 5.00 m/min or less, more preferably 0.10 m/min or more and 1.00 m/min or less, even more preferably 0.20 m/min or more and 0.80 m/min or less, and particularly preferably 0.32 m/min or more and 0.64 m/min or less. The amount of organic compound to be introduced is preferably 1% by volume or more and 70% by volume or less, more preferably 5% by volume or more and 50% by volume or less, even more preferably 10% by volume or more and 40% by volume or less, and particularly preferably 15% by volume or more and 35% by volume or less relative to a total amount of the carrier gas and the organic compound.

Since the carbonization of the carbonaceous layer can also proceed by the CVD reaction, another carbonization treatment is not required but may be performed.

### (Dispersion Liquid)

Next, a dispersion liquid will be described.

The dispersion liquid includes the above-described carbon material and a dispersion medium, in which the carbon material is dispersed in the dispersion medium.

The dispersion medium is appropriately selected depending on the intended use of the dispersion liquid. As the dispersion medium, for example, an organic or inorganic dispersing agent (e.g., a monomolecular or plastic resin material) is suitable for maintaining a good dispersion state of the carbon material in a solvent. When the dispersion liquid is used for producing a lithium ion battery, a polar solvent is suitably used, and from the viewpoint of the affinity with a binder polymer, preferably N,N-dimethylformamide, N-methylpyrrolidone (NMP), N,N-dimethylacetamide or water, and more preferably N-methylpyrrolidone is included. N-methylpyrrolidone is suitable for dispersion of the carbon material.

The ratio of the carbon material to the above-described dispersion medium is appropriately selected depending on the intended use of the dispersion liquid, and the ratio of the carbon material relative to 100 parts by weight of the dispersion medium is preferably 0.01 parts by weight or more and 50.00 parts by weight or less, more preferably 0.05 parts by weight or more and 10.00 parts by weight or less, even more preferably 0.10 parts by weight or more and 5.00 parts by weight, particularly preferably 0.15 parts by weight or more and 4.50 parts by weight or less, and most preferably 0.20 parts by weight or more and 4.00 parts by weight or less. The ratio of the carbon material of 0.01 parts by weight or more makes it easy to form an electrically conductive path in a lithium ion battery, and the ratio of the carbon material of 50.00 parts by weight or less provides a dispersion liquid with good flowability.

Since the carbon material having a high specific surface area tends to agglomerate due to a van der Waals interaction, the dispersion liquid may further include a dispersing agent to improve dispersibility. The dispersing agent may be attached to the carbon material in advance or added directly to the dispersion medium. The dispersing agent is appropriately selected depending on the intended use of the dispersion liquid and one having an acidic group or a basic group can be used. As the dispersing agent, one adsorbing a surface of the carbon material to disperses the carbon material by steric hindrance repulsion or electrostatic repulsion, or one that reduces an interfacial tension between the carbon material and the solvent can be used.

The dispersing agent having an acidic group exerts an effect of enhancing the dispersibility of the carbon material since at least a part of the dispersing agent is present adhering to the surface of the carbon material. The acidic group of the dispersing agent is preferably a phenolic hydroxy group. The dispersing agent having the phenolic hydroxy group is preferably phenol, nitrophenol, cresol, catechol, or a compound in which a structure of the above compound is partially substituted.

Among these, a compound having a catechol group is preferred as the dispersing agent because of its adhesiveness to the carbon material and dispersibility in the dispersion medium. The dispersing agent having a catechol group is preferably catechol, dopamine hydrochloride, 3-(3,4-dihydroxyphenyl)-L-alanine, 4-(1-hydroxy-2-aminoethyl) catechol, 3,4-dihydroxybenzoic acid, 3,4-dihydroxyphenylacetic acid, caffeic acid, 4-methylcatechol, or 4-tert-butylpyrocatechol.

The dispersing agent having a basic group is preferably a compound having an amino group and more preferably a compound having an aromatic ring and an amino group because of its good dispersibility. Benzylamine or phenylethylamine is suitable as such a compound. In addition to the above-described dispersing agent having a basic group, a compound having a basic group and a catechol group is also preferred as the dispersing agent having a basic group, with dopamine hydrochloride being suitable.

A surfactant having an acidic group or a basic group is also suitable as the dispersing agent. The surfactant may be any of a cationic surfactant, an anionic surfactant, or a nonionic surfactant, but the cationic surfactant and the anionic surfactant may itself be involved in an electrochemical reaction. Therefore, a nonionic surfactant that is not ionized is suitable when the dispersion liquid is used as a battery material.

As the dispersing agent for a polymeric compound, one that can also be used as a binder for a battery can be used, and suitable examples thereof include polyvinylidene fluoride, a vinylidene fluoride-chlorotrifluoroethylene copolymer, polyvinylidene fluoride modified with maleic acid, polyvinylpyrrolidone, polyvinyl alcohol, polymethyl vinyl ether, polyacrylonitrile, nitrile rubber, acrylonitrile butadiene rubber, hydrogenated acrylonitrile butadiene rubber, poly(meth)acrylic acid and an ester thereof, polyvinyl acetal, polyvinyl butyral, or cellulose ether.

The dispersing agent may be used alone or two or more thereof may be used in combination, and the amount of the dispersing agent to be included in the dispersion liquid may be appropriately selected depending on the intended use of the dispersion liquid.

The dispersing liquid may further include another carbon material other than the carbon material according to the embodiment, if necessary. Examples of the other carbon material can include, for example, at least one selected from the group consisting of carbon black, graphite, activated carbon, a carbon nanotube, a carbon nanofiber, a carbon fiber, and fullerene.

The carbon black is suitably acetylene black, Ketjen black or furnace black, and from the viewpoint of electrical conductivity, acetylene black or Ketjen black is preferred. Graphite, also known as black lead or plumbago, is a laminate of many layers of graphene. A single-walled carbon nanotube or a multi-walled carbon nanotube (the multi-walled carbon nanotube includes a cup stack type carbon nanotube) is suitable as the carbon nanotube. The carbon fiber is suitably a mesophase pitch-based carbon fiber, an isotropic pitch-based carbon fiber, a vapor grown carbon fiber (VGCF), or a milled carbon fiber obtained by calcining and then pulverizing a polymer fiber.

The other carbon material may be used alone or two or more thereof may be used in combination. The amount of the other carbon material to be used can be appropriately selected depending on the intended use of the dispersion liquid, e.g., within the same range as the carbon material. The ratio of the carbon material according to the embodiment to the other carbon material may be appropriately selected depending on the intended use of the dispersion liquid, and a weight ratio of [Carbon material according to the embodiment]:[Other carbon material] is preferred in the order of 10:90 to 90:10, 20:80 to 80:20, and 40:60 to 60:40.

The solid content concentration of the dispersion liquid is appropriately selected depending on the intended use of the dispersion liquid, and is preferably 0.01% by mass or more and 50.00% by mass or less, more preferably 0.05% by mass or more and 30.00% by mass or less, even more preferably 0.10% by mass or more and 20.00% by mass or less, particularly preferably 0.50% by mass or more and 10.00% by mass or less, and most preferably 1.00% by mass or more and 5.00% by mass or less. When the solid content concentration of the dispersion liquid is 50.00% by mass or less, the carbon material is less likely to be stacked in the dispersion liquid and can maintain a good dispersion state. When the solid content concentration of the dispersion liquid is 0.01% by mass or more, the viscosity of a paste for an electrode can be prevented from decreasing when the dispersion liquid is used to produce the slurry for an electrode, resulting in improved coatability.

The solid content of the dispersion liquid refers to matter remaining after the dispersion medium is removed by drying from the dispersion liquid. The ratio of the solid content of the dispersion liquid can be calculated by measuring a weight of the matter after the dispersion medium is removed by drying from the dispersion liquid, and then dividing the thus-measured value by a weight of the dispersion liquid itself. Specifically, about 1 g of the dispersion liquid is weighed, the dispersion liquid is adhered to a glass substrate having a known weight, the glass substrate is heated on a hot plate regulated to 120° C. for 1.5 hours to volatilize the dispersion medium, and the weight of the residue is measured.

The viscosity of the dispersion liquid is appropriately selected depending on the intended use of the dispersion liquid, and is preferably 20000 cP or less, more preferably 15000 cP or less, and even more preferably 10000 cP or less at a solid content concentration of 3% by mass, a temperature of 23° C., and a shear rate of 1 s⁻¹. The lower limit of the viscosity of the dispersion liquid is preferably 100 cP or more, more preferably 500 cP or more, even more preferably 1000 cP or more, particularly preferably 2000 cP or more, and most preferably 4000 cP or more. The viscosity of the dispersion liquid is preferably 30 cP or less at a solid content concentration of 2% by weight, a temperature of 23° C., and a shear rate of 1 s⁻¹. The viscosity of the dispersion liquid may be adjusted to a predetermined viscosity by adding a surface treatment agent, etc.

Next, a method for producing the dispersion liquid will be described.

The method for producing the dispersion liquid is not particularly limited. For example, the carbon material and, if necessary, a dispersing agent and the other carbon material, are mixed in the dispersion medium.

Since the carbon material has a relatively large BET specific surface area, it is effective to apply a high shear force using a mixer with a strong stirring force in the presence of the carbon material and the dispersion medium in order to disperse the carbon material well in the dispersion liquid. A mixer that can apply a high shear force is suitably a planetary mixer, FILMIX (registered trademark) (PRIMIX Corporation), a rotating and revolving mixer, a planetary ball mill, or a three-roll mill. In order to dissociate stacking between the carbon materials, a strong stirring step may be performed using a high shear mixer stirring at a shear rate of 5000 to 50000 per second. The high shear mixer is preferably a thin film rotation type, a rotor/stator type, or a media mill type, and suitably, for example, FILMIX (registered trademark) Model 30-30 (PRIMIX Corporation), CLEARMIX (registered trademark) CLM-0.8S (M Technique Co., Ltd.), LABSTAR (registered trademark) Mini LMZ015 (Ashizawa Finetech Ltd.), or SUPER SHEAR MIXER (registered trademark) SDRT 0.35-0.75 (SATAKE MultiMix Corporation).

### (Composition for Electrode)

Next, a composition for an electrode will be described.

The composition for an electrode includes the carbon material, an active material, and a binder.

The active material to be included in the composition for an electrode is suitably an active material to be used for the below-described positive electrode or an active material to be used for the below-described negative electrode. The ratio of the active material to the carbon material is appropriately selected depending on the intended use of the composition for an electrode, and the ratio of the carbon material relative to 100 parts by weight of the active material is preferably 0.005 parts by weight or more and 20.000 parts by weight or less, more preferably 0.010 parts by weight or more and 10.000 parts by weight or less, even more preferably 0.050 parts by weight or more and 5.000 parts by weight or less, particularly preferably 0.100 parts by weight or more and 2.000 parts by weight or less, and most preferably 0.500 parts by weight or more and 1.000 parts by weight or less.

The binder to be included in the composition for an electrode is suitably a binder to be used for the positive electrode or a binder to be used for the negative electrode. The amount of the binder to be used is appropriately selected depending on the intended use of the composition for an electrode, and is preferably 0.05 parts by weight or more and 10.00 parts by weight or less, more preferably 0.10 parts by weight or more and 8.00 parts by weight or less, even more preferably 0.50 parts by weight or more and 6.00 parts by weight, particularly preferably 1.00 parts by weight or more and 5.00 parts by weight or less, and most preferably 2.00 parts by weight or more and 4.00 parts by weight or less relative to 100 parts by weight of the active material.

Furthermore, the composition for an electrode may further include another compounding agent, if necessary, in addition to the carbon material, the active material, and the binder. The other compounding agent is not particularly limited as long as it is used for the composition for an electrode in a lithium ion battery. The amount of the other compounding agent to be used is preferably 20 parts by weight or less, more preferably 15 parts by weight or less, even more preferably 10 parts by weight or less, particularly preferably 5 parts by weight or less, and most preferably 2 parts by weight or less relative to 100 parts by weight of the active material.

Next, a method for producing the composition for an electrode will be described.

The method for producing the composition for an electrode is not particularly limited. For example, the carbon material, the active material, the binder, and, if necessary, the other compounding agent are mixed together. Dry mixing or wet mixing with a dispersion medium is suitable as a mixing method.

### (Slurry for Electrode)

Next, a slurry for an electrode will be described.

The slurry for an electrode includes the composition for an electrode and a dispersing medium, in which the composition for an electrode is dispersed in the dispersing medium. The slurry for an electrode may also include an electrolyte solution.

The dispersion medium may be any dispersion medium as long as it can dissolve or disperse the binder, and is suitably a dispersion medium to be used in the below-described positive electrode, a dispersion medium to be used in the below-described negative electrode, or the dispersion medium to be used in the above-described dispersion liquid. The amount of the dispersion medium to be used may be adjusted to give a viscosity so that the slurry for an electrode can be applied onto a current collector.

In the case of a clay-type electrode in which the slurry for an electrode includes an electrolyte solution, the slurry for an electrode is preferably in the form of clay kneaded with the composition for an electrode and the electrolyte solution. In this case, the slurry for an electrode may not include a binder.

Next, a method for producing the slurry for an electrode will be described.

The method for producing the slurry for an electrode is not particularly limited. For example, the composition for an electrode may be mixed in the dispersion medium, or the carbon material, the binder, and the dispersion medium may be mixed together and then mixed with an active material. For mixing the carbon material, the binder, and the dispersing medium, for example, there are methods which mix the dispersion liquid with the binder, or mix the dispersion liquid with a binder solution in which the binder is dissolved or dispersed in the dispersion medium.

The mixing method is not particularly limited and a known mixer or kneader may be used. For the known mixer, an automatic mortar, a homogenizer, a planetary mixer, a homodisper, or a rotating and revolving mixer is preferred, with the planetary mixer being more preferred.

### (Electrode)

Next, an electrode will be described.

The electrode includes the carbon material. The electrode including the carbon material may be one of a negative electrode or a positive electrode, or both a negative electrode and a positive electrode, and can be obtained by applying the slurry for an electrode on a current collector to form a coated film, and then drying the coated film. The electrode including the carbon material is suitable for an electrode, a positive electrode, and a negative electrode for a lithium ion battery because of its excellent rapid discharge property, capacitive property, and charge-discharge property. From the viewpoint of good battery properties, the electrode preferably includes 0.1 wt % or more and 6.0 wt % or less of the carbon material. The current collector is suitably a current collector to be used for the below-described positive electrode or a current collector to be used for the below-described negative electrode.

The method for applying the slurry for an electrode on the current collector is not particularly limited and any known method may be used. Among these, application of the slurry for an electrode by a manual or automatic coater using a baker-type applicator, a film applicator with a micrometer, a bar coater, or a doctor blade is suitable. The drying method is not particularly limited and any known method may be used. Among these, drying by warm air, hot air or low-humidity air, vacuum drying, or irradiation with infrared rays or electron beams is suitable. After the drying, an electrode composite layer may be pressurized using a mold press or a roll press. The pressurization allows a positive electrode composite layer to adhere to the current collector well.

A positive electrode is obtained by applying a slurry made by mixing a positive electrode active material, an electrical conductive assistant to assist electronic conductivity, a binder, and a dispersion medium, onto a metallic foil for current collection such as a rolled aluminum foil to form a coated film, heating and drying the coated film to remove a solvent in the coated film, and then forming the resultant so as to have a predetermined dimension and density. The carbon material can be useful as an electrical conductive assistant. The slurry may include an electrolyte solution.

The positive electrode active material is a compound capable of reversible intercalation and deintercalation of lithium, and specifically may include a lithium composite metal oxide containing lithium and at least one metal selected from the group consisting of cobalt, manganese, nickel, and aluminum.

Among these, the positive electrode active material is suitably a lithium-manganese oxide (suitably LiMnO₂, LiMn₂O₄), a lithium-cobalt oxide (suitably LiCoO₂), a lithium-nickel oxide (suitably LiNiO₂), a lithium-nickel-manganese oxide (suitably LiNi₁₋ₐMnₐO₂ (0<a<1), LiMn_{2-b}NibO₄ (0<b<2)), a lithium-nickel-cobalt oxide (suitably LiNi_{1-c}Co_{c}O₂ (0<c<1)), a lithium-manganese-cobalt oxide (suitably LiCo_{1-d}Mn_{d}O₂ (0<d<1), LiMn₂₋ₑCOₑO₄ (0<e<2)), a lithium-nickel-manganese-cobalt oxide (suitably Li(Ni_{f}Mn_{g}COₕ)O₂ (0<f<1, 0<g<1, 0<h<1, f+g+h=1), Li(NiⱼMnₖCoₘ)O₄ (0<j<2, 0<k<2, 0<m<2, j+k+m=2)), a lithium-nickel-cobalt-transition metal (M) oxide (suitably Li(NiₚCO_{q}MnᵣMₛ)O₂ (M is selected from the group consisting of Al, Fe, V, Cr, Ti, Ta, Mg and Mo, and p, q, r and s are each independently an atomic fraction of an element, 0≤p<1, 0≤q<1, 0≤r<1, 0≤s<1, and p+q+r+s=1)), and any one or two or more of these compounds may be included.

Among these, from the viewpoint of enhancing a capacitive property and stability of a battery, LiCoO₂, LiMnO₂, LiNiO₂, a lithium-nickel-manganese-cobalt oxide (suitably Li(Ni_{0.6}Mn_{0.2}Co_{0.2})O₂, Li(Ni_{0.5}Mn_{0.3}Co_{0.2})O₂, Li(Ni_{0.8}Mn_{0.1}Co_{0.1})O₂), or a lithium-nickel-cobalt-aluminum oxide (suitably LiNi_{0.8}Co_{0.15}Al_{0.05}O₂) is preferred.

As a highly stable positive electrode active material, a lithium atom-containing oxide (suitably an olivine-type lithium-containing phosphate compound) represented by Formula (4) below and having an olivine-type crystal structure is suitable.

LiMₓA₁₋ₓO₄ Formula (4)

In Formula (4) above, M is at least one metallic element selected from the group consisting of Mg, Ti, V, Nb, Ta, Cr, Mn, Fe, Co, Ni, Cu, Zn, Al, Ga, Ge and Sn, A is at least one element selected from the group consisting of Si, S, P and V, and x is greater than 0 and less than 1. Note that the value of x in Formula (4) is selected so that an overall valence of Formula (4) is zero depending on the valences of M and A.

An organic compound such as polyaniline, polypyrrole, polyacene, a disulfide compound, a polysulfide compound, or an N-fluoropyridinium salt is also suitable as the positive electrode active material.

The physical properties of the positive electrode active material are determined from the requirements in battery design and manufacturing processes due to a constraint condition such as the usage form of a lithium ion battery. In the production of the positive electrode active material, process design is performed to realize the physical properties. The physical properties include powder particle size and distribution, specific surface area, density, etc.

By way of example, the powder particle size is appropriately selected taking a balance with another constituent requirement of the lithium ion battery into consideration and, from the viewpoint of improving a battery property such as a rate property or a cycle property, is preferably 1 μm or more and 30 μm or less and more preferably 1 μm or more and 10 μm or less on average.

The positive electrode active material may be used alone or two or more thereof may be used in combination.

Since the positive electrode active material generally has low electron conductivity, an electrical conductive assistant that assists electron conductivity preferably coexists in the positive electrode, and the carbon material according to the embodiment is suitable for the electrical conductive assistant of the positive electrode. When the electrical conductive assistant is the carbon material, the amount of the electrical conductive assistant (the carbon material) to be used is appropriately selected depending on the intended use of the electrode, and is preferably 0.01 parts by weight or more and 4.00 parts by weight or less, more preferably 0.05 parts by weight or more and 3.00 parts by weight or less, even more preferably 0.10 parts by weight or more and 2.00 parts by weight or less, particularly preferably 0.20 parts by weight or more and 1.50 parts by weight or less, and most preferably 0.50 parts by weight or more and 1.50 parts by weight or less relative to 100 parts by weight of the positive electrode active material.

The electrical conductive assistant can be a combination of the carbon material with another electrically conductive material. The other electrically conductive material is suitably a carbon-based substance such as graphite, carbon black, a carbon nanotube, acetylene black, Ketjen black, channel black, furnace black, lamp black or thermal black, an electrically conductive fiber such as a carbon fiber or a metal fiber, fluorinated carbon, metal powder such as aluminum powder or nickel powder, an electrically conductive whisker of zinc oxide, potassium titanate or the like, an electrically conductive metal oxide such as titanium oxide, or an electrically conductive material such as a polyphenylene derivative.

The other electrically conductive material may be used alone or two or more thereof may be used in combination. The amount of the other electrically conductive material to be used is appropriately selected depending on the intended use of an electrode and is appropriately selected within the same range as for the carbon material. The ratio of the carbon material to the other electrically conductive material is appropriately selected depending on the intended use of an electrode, and a weight ratio of [Carbon material]:[Other electrically conductive material] is preferably 10:90 to 90:10, more preferably 20:80 to 80:20, even more preferably 30:70 to 70:30, and particularly preferably 40:60 to 60:40.

In addition, the carbon material can be combined with a conventionally used electrical conductive assistant to obtain a further effect. For example, carbon black such as acetylene black is formed by combining particles each having a diameter of several tens of nanometers, is not so crystalline of carbon, has a short structure, and is fragile, making long-distance electron transfer difficult. A combination of carbon black with the carbon material can realize a system that retains electronic conductivity and simultaneously has an ion supply capacity even when three-dimensional structure is retained or even when three-dimensional structure is crushed and flattened like flaky graphite.

The binder for a positive electrode is a component that aids in bonding among a positive electrode active material, an electrical conductive assistant and a current collector, and is usually an organic polymer. Suitable examples of the binder include a fluororesin such as polyvinyl fluoride, polyvinylidene fluoride (PVDF) or polytetrafluoroethylene; a CN group-containing polymer such as polyacrylonitrile or polyvinylidene cyanide; a polyvinyl alcohol-based polymer such as polyvinyl acetate or polyvinyl alcohol; a halogen-containing polymer such as polyvinyl chloride or polyvinylidene chloride; an electrically conductive polymer such as polyaniline; an alkane polymer such as polyethylene, polypropylene or poly-1,1-dimethylethylene; an unsaturated polymer such as polybutadiene or polyisoprene; a ring-containing polymer such as polystyrene, polymethyl styrene, polyvinyl pyridine or poly-N-vinylpyrrolidone; or an acrylic polymer such as polymethyl methacrylate, polyethyl methacrylate, polybutyl methacrylate, polymethyl acrylate, polyethyl acrylate, polyacrylic acid, polymethacrylic acid or polyacrylamide. The binder may also be a modified form or a derivative of the organic polymer.

Among these, the binder is preferably a fluororesin, especially polyvinylidene fluoride (PVDF). The weight average molecular weight of the binder may be appropriately selected depending on the intended use of an electrode, is preferably 10000 or more and 8000000 or less, and is preferred in the order of 10000 or more and 5000000 or less, 50000 or more and 3000000 or less, 80000 or more and 3000000 or less, and 100000 or more and 1000000 or less. The weight average molecular weight of the binder of 10000 or more improves the strength of the coated film, and the weight average molecular weight of the binder of 8000000 or less reduces the viscosity, making it easier to form an electrode.

The binder may be used alone or two or more thereof may be used in combination. The amount of the binder to be used is appropriately selected depending on the intended use of an electrode, and is preferably 0.01 parts by weight or more and 4.00 parts by weight or less, more preferably 0.05 parts by weight or more and 3.00 parts by weight or less, even more preferably 0.10 parts by weight or more and 2.00 parts by weight or less, particularly preferably 0.20 parts by weight or more and 1.50 parts by weight or less, and most preferably 0.50 parts by weight or more and 1.50 parts by weight or less relative to 100 parts by weight of a positive electrode active material. When the amount of the binder to be used falls within the above range, adhesiveness between the positive electrode active materials and between the positive electrode active material and the electrical conductive assistant can be improved, which can improve the bonding strength between these materials and the current collector.

The slurry for forming a positive electrode is a mixture of the positive electrode active material, the electrical conductive assistant, and the binder in a dispersion medium. The slurry for forming a positive electrode may also include an electrolyte solution. This is called a clay-type electrode. When the slurry for forming a positive electrode includes an electrolyte solution, the slurry for forming a positive electrode is preferably in the form of clay kneaded with the positive electrode active material, the electrical conductive assistant, the electrolyte solution. In this case, the slurry for forming a positive electrode may not necessarily include the binder.

The slurry for forming a positive electrode may also include another compounding agent, if necessary. The other compounding agent is appropriately selected depending on the intended use of an electrode, and one to be used in a lithium ion battery can be used in an amount in a commonly used range.

The dispersion medium for the slurry is not particularly limited, and is suitably one that dissolves only a binder and does not dissolve other components in order to enable sufficiently uniform distribution of the binder and to form the slurry into a coated film with a predetermined dimension. Among these, an organic solvent such as dimethylformamide, N-methyl-2-pyrrolidone (NMP), dimethyl sulfoxide (DMSO), isopropyl alcohol or acetone, or water is suitable. One of them may be used alone, or two or more thereof may be used in combination.

When polyvinylidene fluoride is used as the binder, the dispersion medium is preferably dimethylformamide or N-methyl-2-pyrrolidone (NMP) and more preferably NMP.

The solid content concentration of the slurry for forming a positive electrode excluding the dispersion medium may be appropriately selected depending on the method for applying the slurry to the current collector, and is preferably 10% by weight or more and 90% by weight or less, more preferably 20% by weight or more and 80% by weight or less, even more preferably 40% by weight or more and 80% by weight or less, particularly preferably 40% by weight or more and 70% by weight or less, and most preferably 50% by weight or more and 65% by weight or less.

The viscosity of the slurry for forming a positive electrode is preferably 1000 cP or more and 50000 cP or less, more preferably 2000 cP or more and 40000 cP or less, even more preferably 5000 cP or more and 35000 cP or less, particularly preferably 10000 cP or more and 35000 cP or less, and most preferably 10000 cP or more and 30000 cP or less at a temperature of 24° C. or more and 26° C. or less. When the viscosity of the slurry for forming a positive electrode falls within the above range, the slurry for forming a positive electrode can be applied at a uniform thickness, while the solid content excluding the dispersion medium is constantly dispersed.

A positive electrode can be produced by applying the slurry for forming a positive electrode on a current collector, and then drying it if necessary. The current collector for the positive electrode is not particularly limited as long as it is commonly used, and is preferably an aluminum foil, a nickel foil, a titanium foil or a stainless foil, and more preferably a rolled aluminum foil.

As the method for applying the slurry for forming a positive electrode to the current collector, a commonly used printing technique can be used. Gravure printing is suitable in the case of the coated film with a thin thickness dimension, while doctor blade printing, die printing, etc., are suitable in the case of the coated film with a thick thickness dimension.

The coated film is then dried by heating if necessary. Any drying method can be used, and a method that can achieve a desired bonding strength with the binder is suitable.

After the drying, when a positive electrode is formed into a predetermined dimension, an industrially available cutting blade is suitably used. In order to achieve a predetermined density, an industrially available pressurization device is suitably used, if necessary.

Furthermore, a negative electrode is obtained by applying a slurry made by mixing a negative electrode active material, an electrical conductive assistant, a binder and a dispersion medium onto a metallic foil for current collection such as a rolled copper foil to form a coated film, heating and drying the coated film to remove a solvent in the coated film, and then forming the resultant so as to have a predetermined dimension and a predetermined dimension density. The slurry may include an electrolyte solution.

The negative electrode active material is preferably one that can stably bind a Li ion to an electron flowing from an external circuit and that has many stabilization sites inside therein. The negative electrode active material is derived from an organic matter and its crystallinity may be high or low, with graphite, coke, amorphous carbon, hard carbon or polymeric carbon being suitable. In this case, in principle, the Li ion is stabilized by binding to the electron in a state where the Li ion is sandwiched, for example, between graphene layers. Another stabilization mechanism in which an intermetallic compound is electrochemically formed is also available, and silicon, tin, zinc, bismuth, antimony, cadmium, lead or germanium is suitably used. In addition, another material exhibiting a low electrochemical reaction potential can also be used for negative electrode side of a lithium ion battery, is also available. Suitable examples thereof include a compound of a metal with oxygen, sulfur, a halogen, nitrogen, phosphorus or the like.

Specific examples of the negative electrode active material include a compound capable of reversible intercalation and deintercalation of lithium, e.g., a carbonaceous material such as artificial graphite, natural graphite, a graphitized carbon fiber or amorphous carbon; a metallic compound capable of alloying with lithium such as Si, Al, Sn, Pb, Zn, Bi, In, Mg, Ga, Cd, Si alloy, Sn alloy or Al alloy; a metal oxide that can be doped and de-doped with lithium such as SiOx (0<x≤2), SnO₂, vanadium oxide or lithium vanadium oxide; a composite including the metallic compound and the carbonaceous material such as a Si—C composite or a Sn—C composite.

A metallic lithium thin film is also suitable as the negative electrode active material. The carbonaceous material may be either low-crystalline carbon or high-crystalline carbon. The low-crystalline carbon is suitably softening carbon or hardening carbon, while the high-crystalline carbon is suitably amorphous, plate-like, flaky, spherical, or fibrous natural or artificial graphite, kish graphite, pyrolytic carbon, a mesophase pitch-based carbon fiber, a meso carbon microsphere, a mesophase pitch, or high temperature-calcined carbon such as petroleum and coal-based coke.

The physical properties of the negative electrode active material are determined from the requirements in device (e.g., storage battery) design and manufacturing processes due to a constraint condition such as the usage form of a lithium ion battery. In the production of the negative electrode active material, process design is performed to realize the physical properties. The physical properties include powder particle size and distribution, specific surface area, density, etc.

By way of example, the powder particle size is appropriately selected taking a balance with another constituent requirement of the lithium ion battery into consideration and, from the viewpoint of improving a battery property such as a rate property or a cycle property, is preferably 1 μm or more and 70 μm or less and more preferably 3 μm or more and 30 μm or less on average.

The negative electrode active material may be used alone or two or more thereof may be used in combination. The ratio of the negative electrode active material in a slurry for forming a negative electrode is not particularly limited, and is preferably 95.5 parts by weight or more and 99.0 parts by weight or less, more preferably 96.0 parts by weight or more and 98.7 parts by weight or less, and even more preferably 97.0 parts by weight or more and 98.0 parts by weight or less relative to 100 parts by weight of a solid content of the slurry for forming a negative electrode excluding a dispersion medium. When the ratio of the negative electrode active material falls within the above range, battery capacity, electrical conductivity, and adhesiveness are highly balanced.

The carbon material according to the embodiment may be used as the negative electrode active material and can be suitably used as an electrical conductive assistant for a negative electrode. For example, the above-described negative electrode active material generally has high electronic conductivity, but when it has a smooth surface and interparticle contact is insufficient for some materials, the carbon material can be used as an electrical conductive assistant to assist in electron conductivity. Flaky graphite or artificial graphite serving as the negative electrode active material has high electron conductivity but a low ion storage property and poor ionic conductivity. A combination of a material with such properties with the carbon material enables construction of a good battery reaction aid system that adds ionic conductivity to electron conductivity. Furthermore, even when three-dimensional structure of a negative electrode active material is crushed and flattened like flaky graphite, the carbon material can be applied to add ion conductivity while retaining electron conductivity.

When an electrical conductive assistant is the carbon material, a ratio of the electrical conductive assistant (the carbon material) in a slurry for forming a negative electrode is preferably 0.8 parts by weight or more and 3.0 parts by weight or less, more preferably 1.0 part by weight or more and 2.5 parts by weight or less, and even more preferably 1.0 part by weight or more and 2.2 parts by weight or less relative to 100 parts by weight of a solid content of the slurry for forming a negative electrode excluding a dispersion medium. When the ratio of the electrical conductive assistant falls within the above range, a rapid charge property, a life property, a capacitive property, and a charge-discharge property of a lithium ion battery can be further enhanced.

The electrical conductive assistant can be a combination of the carbon material with another carbon material. The other carbon material is not particularly limited as long as it is conventionally used as an electrode material, and suitable examples thereof include acetylene black, Ketjen black, lamp black, furnace black, carbon black, graphite, a carbon fiber, a graphite fiber, a nanofiber, a nanotube, coke, hard carbon, and amorphous carbon.

The other carbon material may be used alone or two or more thereof may be used in combination. The amount of the other carbon material to be used is appropriately selected depending on the intended use of an electrode and is appropriately selected within the same range as for the carbon material according to the embodiment. The ratio of the carbon material to the other carbon material is preferably 10:90 or more and 90:10 or less, more preferably 20:80 or more and 80:20 or less, even more preferably 30:70 or more and 70:30 or less, and particularly preferably 40:60 or more and 60:40 or less as expressed as a weight ratio of [Carbon material]:[Other carbon material].

Further effect can be achieved by a combined use of the carbon material according to the embodiment with such a conventional electrical conductive assistant. For example, a highly linear carbon nanotube has high electronic conductivity but has a low ion storage property. Therefore, a combination of it with the carbon material enables construction of a good battery reaction aid system that adds ionic conductivity to electron conductivity. Furthermore, carbon black such as acetylene black is formed by combining particles each having a diameter of several tens of nanometers, is not so crystalline of carbon, has a short structure, and is fragile, making long-distance electron transfer difficult. A combination of carbon black having such properties with the carbon material can realize a system that has an ion supply capacity while retaining three-dimensional structure.

The binder for a negative electrode is a component that aids in bonding among a negative electrode active material, an electrical conductive assistant and a current collector, and is usually an organic polymer. Suitable examples of the binder include a fluororesin such as polyvinyl fluoride, polyvinylidene fluoride or polytetrafluoroethylene; a CN group-containing polymer such as polyacrylonitrile or polyvinylidene cyanide; a polyvinyl alcohol-based polymer such as polyvinyl acetate or polyvinyl alcohol; a halogen-containing polymer such as polyvinyl chloride or polyvinylidene chloride; an electrically conductive polymer such as polyaniline; an alkane polymer such as polyethylene, polypropylene or poly-1,1-dimethylethylene; an unsaturated polymer such as polybutadiene or polyisoprene; a ring-containing polymer such as polystyrene, polymethylstyrene, polyvinyl pyridine or poly-N-vinylpyrrolidone; an acrylic polymer such as polymethyl methacrylate, polyethyl methacrylate, polybutyl methacrylate, polymethyl acrylate, polyethyl acrylate, polyacrylic acid, polymethacrylic acid or polyacrylamide; carboxymethyl cellulose; or a styrene-butadiene rubber. The binder may also be a modified form or a derivative of the organic polymer.

Among these, carboxymethyl cellulose or styrene-butadiene rubber is preferred as the binder. The weight average molecular weight of the binder may be appropriately selected depending on the intended use of an electrode, is preferably 10000 or more and 8000000 or less, and is preferred in the order of 10000 or more and 5000000 or less, 50000 or more and 5000000 or less, 80000 or more and 3000000 or less, and 100000 or more and 1000000 or less. The weight average molecular weight of the binder of 10000 or more improves the strength of the coated film, and the weight average molecular weight of the binder of 8000000 or less reduces the viscosity, making it easier to form an electrode.

The binder may be used alone or two or more thereof may be used in combination, and an amount of the binder to be used is appropriately selected depending on the intended use of an electrode and is preferably 0.01 parts by weight or more and 4.00 parts by weight or less, more preferably 0.05 parts by weight or more and 3.00 parts by weight or less, even more preferably 0.10 parts by weight or more and 2.00 parts by weight or less, particularly preferably 0.20 parts by weight or more and 1.50 parts by weight or less, and most preferably 0.50 parts by weight or more and 1.50 parts by weight or less relative to 100 parts by weight of a negative electrode active material. When the amount of the binder to be used falls within the above range, adhesiveness between the negative electrode active materials and between the negative electrode active material and the electrical conductive assistant can be improved, which can improve the bonding strength between these materials and the current collector.

Furthermore, the ratio of the binder in a slurry for forming a negative electrode is preferably 0.8 parts by weight or more and 3.0 parts by weight or less, more preferably 1.0 part by weight or more and 2.5 parts by weight or less, and even more preferably 1.0 part by weight or more and 2.2 parts by weight or less relative to 100 parts by weight of the solid content of the slurry for forming a negative electrode excluding a dispersion medium. When the ratio of the binder in the slurry for forming a negative electrode falls within the above range, adhesiveness between the negative electrode active materials and between the negative electrode active material and the electrical conductive assistant can be improved, which can improve the bonding strength between these materials and the current collector.

The slurry for forming a negative electrode is a mixture of the negative electrode active material, the electrical conductive assistant, and the binder in a dispersion medium. The slurry for forming a negative electrode may also include an electrolyte solution. This is called a clay-type electrode. When the slurry for forming a negative electrode includes an electrolyte solution, the slurry for forming a negative electrode is preferably in the form of clay kneaded with the negative electrode active material, the electrical conductive assistant, the electrolyte solution. In this case, the slurry for forming a negative electrode may not necessarily include the binder.

The dispersion medium of the slurry is not particularly limited as long as it is a solvent commonly used in the art. Suitable examples thereof include an organic solvent such as N-methyl-2-pyrrolidone (NMP), dimethyl sulfoxide (DMSO), isopropyl alcohol or acetone, or water. One of them may be used alone, or two or more thereof may be used in combination. The dispersion medium is used to dissolve or disperse the negative electrode active material, the electrical conductive assistant, and the binder, taking a coating thickness of the slurry for forming a negative electrode or fabrication yield into consideration.

The amount of the dispersion medium to be used is not particularly limited, but is adjusted so that a concentration of a solid content including the negative electrode active material, the electrical conductive assistant, and the binder in the slurry for forming a negative electrode is preferably 10% by weight or more and 90% by weight or less, more preferably 20% by weight or more and 80% by weight or less, even more preferably 30% by weight or more and 75% by weight or less, particularly preferably 40% by weight or more and 70% by weight or less, and most preferably 50% by weight or more and 65% by weight or less.

The current collector for a negative electrode is not particularly limited and, for example, a material that is not electrochemically reactive to a potential developed by the negative electrode is used. Suitable examples of the current collector include a copper foil, a nickel foil, a titanium foil, or a stainless foil, with an electrolytic copper foil or a rolled copper foil being more preferred.

For the method for applying the slurry for forming a negative electrode to the current collector, a commonly used printing technique can be used. Gravure printing is suitable in the case of the coated film with a thin thickness dimension, while doctor blade printing, die printing, etc., are suitable in the case of the coated film with a thick thickness dimension.

The coated film is then dried by heating if necessary. Any drying method can be used, and a method that can achieve a desired bonding strength with the binder is suitable.

After the drying, when a negative electrode is formed into a predetermined dimension, an industrially available cutting blade is suitably used. In order to achieve a predetermined density, an industrially available pressurization device is suitably used, if necessary.

A dry electrode is one that a dry mixed composition of an active material, an electrically conductive agent, and a binder is spread on a current collector in advance and then pressure molding is conducted by, for example, a roll press without using a liquid slurry for an electrode with a conventional volatile solvent (e.g., N-methylpyrrolidone or water).

Examples of advantages thereof include disuse of environmental pollutants from volatile solvents during drying, disuse of electrical energy for drying, and elimination of capital investment in the facility related thereto.

Specifically, the dry electrode can be produced as follows.

For the dry mixed composition, a microsphere emulsion mainly composed of a fluororesin is suitably used as the binder, and a micro- to nano-scale fibrillated fiber generated during a mixing process suitably holds the active material or the electrically conductive agent. A thin film electrode is obtained by injecting or spraying precursor powder obtained by pulverizing and classifying a bulky dry mixed composition on an aluminum current collector, with a thin coating of an anchor layer mixed with carbon and resin if necessary, to form a thin layer, charging the resultant into a hot roll press, etc., and then pressurizing it.

The precursor powder has a particle size of several tens of micrometer and causes no migration occurring at solvent volatilization, unlike conventional liquid slurries, making it possible to suitably produce a thick electrode.

The dry electrode can be produced as not only a positive electrode but also a negative electrode, and a battery with a cylindrical, square or pouch shape can be suitably produced using a common separator and a liquid or semi-solid electrolyte (gel electrolyte) as an electrolyte.

### (Lithium Ion Battery)

Next, a lithium ion battery will be described.

The lithium ion battery includes the carbon material. Specifically, the lithium ion battery has a positive electrode, a negative electrode, a separator interposed between the positive electrode and the negative electrode, and an electrolyte, and at least one of the positive electrode or the negative electrode, preferably both the positive electrode and the negative electrode, is/are the electrode (the positive electrode, the negative electrode) according to the embodiment. The electrolyte is preferably a liquid electrolyte or a semi-solid electrolyte because the carbon material can hold an electrolyte solution therein and, in this case, at least one of the positive electrode or the negative electrode is preferably a dry electrode. The lithium ion battery preferably includes a clay-type positive electrode including the carbon material and a clay-type negative electrode including the carbon material. The lithium ion battery may further include a battery container that contains an electrode assembly including the positive electrode, the negative electrode, and the separator, and a sealing member that seals the battery container. Since the positive electrode and the negative electrode of the lithium ion battery are substantially the same as the positive electrode and the negative electrode described above, specific descriptions thereof are omitted.

The separator of the lithium ion battery separates the negative electrode from the positive electrode and provides a moving path of lithium ions, and is not particularly limited as long as it is usually used as a separation membrane in a lithium ion battery. The separator preferably has low resistance to the ion movement in the electrolyte while having an excellent electrolyte impregnation capacity.

Specific examples of the separator include a porous polymer film, with a porous polymer film made of polyolefin such as polyethylene, polypropylene, polybutene, polyvinyl chloride, an ethylene/butene copolymer, an ethylene/hexene copolymer or an ethylene/methacrylate copolymer, or a laminated structure of two or more layers of these films being preferred. The separator is suitably a common porous non-woven fabric, for example, a non-woven fabric made of a high melting point glass fiber, a polyethylene terephthalate fiber, etc. A separation membrane coated with a coating solution including a ceramic component or a polymeric substance is also suitable to ensure the heat resistance or the mechanical strength. The separator may selectively be used in a single-layer or multi-layer structure.

Polyethylene or polypropylene is a suitable material for the porous polymer film. Polyethylene has a relatively low melting temperature, and thus, when the temperature of the battery increases for some reason (e.g., an unsafe condition such as a short circuit), the pores in the film are closed by thermal melting and the movement of driving ions is inhibited, thereby stopping the reaction and ensuring safety. Furthermore, polypropylene is suitable because it can be made stretchable and porous without using a plasticizer.

Further, a polymeric compound may be applied to both sides of the separator. The polymeric compound to be applied onto the surface of the separator may be gelled by an electrolyte solution. Suitable examples of the polymeric compound include an ether-based polymeric compound such as polyvinyl formal, polyethylene oxide or a cross-linked compound containing polyethylene oxide; an ester-based polymeric compound such as polymethacrylate; an acrylate-based polymeric compound; or a fluorine-based polymer compound such as polyvinylidene fluoride or a vinylidene fluoride-hexafluoropropylene copolymer. Among these, a fluorine-based polymer compound is preferred and polyvinylidene fluoride is more preferred from the viewpoint of prevention of swelling during storage at a high temperature, and gelation.

The electrolyte solution of the lithium ion battery is usually a non-aqueous electrolyte solution which dissolves an electrolyte in an organic solvent.

A lithium salt is suitable as an electrolyte for the lithium ion battery. Preferred examples of the lithium salt include LiPF₆, LiAsF₆, LiBF₄, LiSbF₆, LiAlCl₄, LiClO₄, CF₃SO₃Li, C₄F₉SO₃Li, CF₃COOLi, (CF₃CO)₂NLi, (CF₃SO₂)₂NLi, (C₂F₅SO₂)NLi, LiN(CF₃SO₂)₂, LiN(C₂F₅SO₂)₂, LiN(CF₃SO₂)(C₄F₉SO₂), LiC(CF₃SO₂)₃, LiPF₄(CF₃)₂, LiPF₄(C₂F₅)₂, LiPF₄(CF₃SO₂)₂, LiPF₄(C₂F₅SO₂)₂, LiBF₂(CF₃)₂, LiBF₂(C₂F₅)₂, LiBF₂(CF₃SO₂)₂, LiBF₂(C₂F₅SO₂)₂, Li-cyclic-1,2-perfluoroethane disulfonylimide, or Li-cyclic-1,3-perfluoropropane disulfonylimide. Among these, LiPF₆, LiBF₄, LiClO₄, CF₃SO₃Li, LiN(CF₃SO₂)₂, or LiN(C₂F₅SO₂)₂ is preferred, and LiPF₆ or LiBF₄ is more preferred since they are easily dissolved in a solvent and exhibit a high degree of dissociation.

A gel-like electrolyte gelled by including a polymeric compound that swells with an organic solvent and serves as a holder for holding a non-aqueous electrolyte is a suitable electrolyte. It can obtain high ionic conductivity by including the polymeric compound that swells with an organic solvent, which results in excellent charge-discharge efficiency and prevention of battery leakage. The content of the polymeric compound is preferably 0.1% by weight or more and 10.0% by weight or less of the electrolyte. The polymeric compound is preferably polyvinylidene fluoride.

The electrolyte may be used alone or two or more thereof may be used in combination. The concentration of the electrolyte in the electrolyte solution is preferably 5% by weight or more and 15% by weight or less, more preferably 2% by weight or more and 13% by weight or less, and even more preferably 5% by weight or more and 10% by weight or less.

An organic solvent for the electrolyte solution is not particularly limited as long as it can dissolve the electrolyte, and is suitably a cyclic carbonate, a chain carbonate, an ester such as γ-butyrolactone or methyl formate, an ether such as 1,2-dimethoxyethane or tetrahydrofuran, or a sulfur-containing compound such as sulfolane or dimethyl sulfoxide. The organic solvent may be used alone or two or more thereof may be used in combination.

Among these, a cyclic carbonate or a chain carbonate is suitable because of its high dielectric constant and suitable viscosity and solvating ability that affect the movement of Li ion. Note that the solvating ability refers to a force that dissociates a dissolved ion, and there is an optimum value because an excessively strong solvating ability inhibits the ion movement.

Suitable examples of the cyclic carbonate include an alkylene carbonate having an alkylene group with 2 or more and 4 or less carbon atoms such as ethylene carbonate, propylene carbonate, or butylene carbonate. Among these, ethylene carbonate or propylene carbonate is preferred, and ethylene carbonate is more preferred from the viewpoint of improving battery properties.

The chain carbonate is preferably a dialkyl carbonate. The alkyl group constituting it preferably has 1 or more and 5 or less carbon atoms and more preferably 1 or more and 4 or less carbon atoms. Specifically, the chain carbonate is suitably a dialkyl carbonate, for example, a symmetrical chain alkyl carbonate such as dimethyl carbonate, diethyl carbonate or di-n-propyl carbonate, or an asymmetrical chain alkyl carbonate such as ethyl methyl carbonate, methyl-n-propyl carbonate or ethyl-n-propyl carbonate. Among these, dimethyl carbonate or diethyl carbonate is preferred, and diethyl carbonate is more preferred from the viewpoint of viscosity or boiling point.

Furthermore, a mixture of the cyclic carbonate and the chain carbonate is preferably used since a practical lithium ion battery has a wide range of environmental conditions for use and needs to have physical properties such as melting point or boiling point of a non-aqueous solvent kept within a certain range.

The combination of the cyclic carbonates and the chain carbonates is suitably a combination of ethylene carbonate and a chain carbonate. Specifically, ethylene carbonate and dimethyl carbonate; ethylene carbonate and diethyl carbonate; ethylene carbonate, dimethyl carbonate and diethyl carbonate; ethylene carbonate, dimethyl carbonate and ethyl methyl carbonate; or ethylene carbonate, dimethyl carbonate, diethyl carbonate and ethyl methyl carbonate are preferred due to a good balance between a cycle property and a high power discharge property.

The mixing ratio of the cyclic carbonate to the chain carbonate is appropriately selected depending on the desired practical property, and the weight ratio of [Cyclic carbonate]:[Chain carbonate] is preferably 10:90 to 90:10, more preferably 20:80 to 80:20, even more preferably 30:70 to 70:30, and particularly preferably 40:60 to 60:40.

The ratio of the cyclic carbonate in the electrolyte is preferably 1% by weight or more and 70% by weight or less, and is preferred in the order of 1% by weight or more and 35% by weight or less, 3% by weight or more and 30% by weight or less, and 4% by weight or more and 50% by weight or less. A plurality of kinds of cyclic carbonates may be mixed together. The ratio of the chain carbonate in the electrolyte is preferably 40% by weight or more and 70% by weight or less, and more preferably 43% by weight or more and 68% by weight or less. A plurality of kinds of chain carbonates may be mixed together.

The organic solvent is suitably a fluorine-containing carbonate. Specifically, a cyclic carbonate having one fluorine atom, a chain carbonate having one fluorine atom, a cyclic carbonate having two or more fluorine atoms, or a chain carbonate having two or more fluorine atoms is preferred and, from the viewpoint of improving a battery property, a fluorine-containing cyclic carbonate having two or more fluorine atoms is more preferred.

The fluorine-containing cyclic carbonate having two or more fluorine atoms is preferably cis-4,5-difluoro-1,3-dioxolane-2-one, trans-4,5-difluoro-1,3-dioxolane-2-one, or 4,4-difluoro-1,3-dioxolane-2-one.

The fluorine-containing carbonate may be used alone or two or more thereof may be used in combination. The ratio of the fluorine-containing carbonate in the electrolyte solution is preferably 0.001% by weight or more and 10.000% by weight or less, more preferably 0.010% by weight or more and 5.000% by weight or less, even more preferably 0.100% by weight or more and 2.000% by weight or less, particularly preferably 0.200% by weight or more and 1.000% by weight or less, and most preferably 0.250% by weight or more and 0.500% by weight or less. When the ratio of the fluorine-containing carbonate is 0.001% by weight or more, the effect of the fluorine-containing carbonate is developed well, and when the ratio of the fluorine-containing carbonate is 10.000% by weight or less, an increase in internal pressure of the battery during storage at a high temperature can be suppressed.

As an organic solvent, a cyclic carbonate having an unsaturated bond or an aromatic compound having 7 or more and 18 or less carbon atoms may also be mixed in an electrolyte.

The cyclic carbonate having an unsaturated bond is preferably vinylene carbonate, vinylethylene carbonate, 4-methyl-4-vinyl ethylene carbonate or 4,5-divinyl ethylene carbonate, and is more preferably vinylene carbonate or vinyl ethylene carbonate from the viewpoint of improving a cycle property.

The aromatic compound having 7 or more and 18 or less carbon atoms is suitably an aromatic compound such as biphenyl, alkylbiphenyl, terphenyl, a partially hydrogenated compound of terphenyl etc., cyclohexylbenzene, t-butylbenzene, t-amyl benzene, diphenyl ether, or dibenzofuran from the viewpoint of suppressing a significant decrease in a discharge property after storage at a high temperature by suppressing side reaction with the negative electrode or the positive electrode.

The cyclic carbonate having an unsaturated bond or the aromatic compound having 7 or more and 18 or less carbon atoms can be used alone or two or more thereof may be used in combination, and a ratio of each of them in an electrolyte solution is preferably 0.001% by weight or more and 5.000% by weight or less, more preferably 0.100% by weight or more and 4.000% by weight or less, even more preferably 0.300% by weight or more and 3.000% by weight or less, particularly preferably 0.400% by weight or more and 2.500% by weight or less, and most preferably 0.500% by weight or more and 2.000% by weight or less. When the ratio is 0.001% by weight or more, safety upon overcharging can be further improved. When the ratio is 5.000% by weight or less, a battery property such as a storage property at high temperature can be further improved.

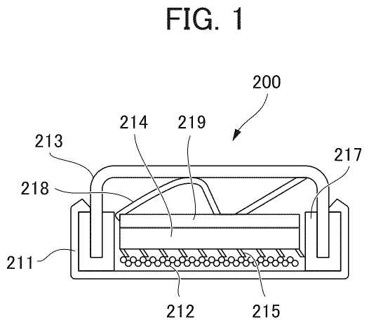

FIG. 1 is a cross-sectional view showing one exemplary lithium ion battery according to the embodiment and, specifically, a cross-sectional view showing one exemplary cross-sectional structure of a coin-type lithium ion battery. As shown in FIG. 1, a lithium ion battery 200 has a disc-shaped positive electrode 212 housed in a metallic outer component 211 and a disc-shaped negative electrode 214 housed in a metallic outer component 213, with the positive electrode 212 and the negative electrode 214 being laminated via a separator 215. A metallic spring 218 and a spacer 219 are placed between the outer component 213 and the negative electrode 214. An interior of the outer component 211 and the outer component 213 is filled with a liquid electrolyte. A periphery of the outer component 211 and a periphery of the outer component 213 are sealed by crimping through a sealing gasket 217.

For example, the lithium ion battery can be manufactured by superposing the positive electrode and the negative electrode via the separator, rolling and/or folding them as needed depending on a shape of the battery, entering the resultant into a battery container, filling the battery container with an electrolyte solution, and then sealing the battery container. In order to prevent an increase in pressure inside the lithium ion battery and over-charge/discharge, an overcurrent protection element such as a fuse or a PTC element, an expanded metal, a lead plate, etc., may be provided as necessary. The shape of the lithium ion battery can be, for example, any of coin-shaped, button-shaped, sheet-shaped, cylindrical, rectangular, or flat.

Although embodiments have been described above, the present invention is not limited to the embodiments and includes various modes falling within the gist of the present disclosure and the scope of the claims, and various modifications may be made within the scope of the present disclosure.

### EXAMPLES

Next, Examples and Comparative Examples will be described, but the present invention is not limited to these Examples. Note that, in the following, the terms “%”, “ppm”, and “part(s)” representing an amount are on a weight basis unless otherwise noted.

### Experiment 1: Production of Carbon Material, Dispersion Liquid, Composition for Electrode, Slurry for Electrode, Electrode, and Lithium Ion Battery

### Example 1

### (Production of Carbon Material)

### —CVD Reaction: Formation of Carbonaceous Layer on Template Material (Template)—

About 1 g of fumed silica (SiO₂/AEROSIL (registered trademark) NX90G, particle size: 38 nm, BET specific surface area: 71 m²/g, carbon content 0.5 to 1.5%, manufactured by NIPPON AEROSIL CO., LTD.) serving as a raw material for a template material was spread on a quartz boat, and the quartz boat was placed in the center of a quartz reaction tube in a horizontal CVD device (transparent electric furnace manufactured by ISHIKAWA TRADING CO., LTD.). The temperature was increased to 900° C. at a temperature rising rate of 10° C./min, and was held for 30 minutes while allowing argon gas to flow inside the reaction tube at a flow velocity of 400 mL/min. The argon gas was flowed at a flow velocity of 320 mL/min and, at the same time, methane gas was flowed at a flow velocity of 80 mL/min (raw material gas concentration 20%) while the temperature was maintained at 900° C. for 90 minutes. The temperature was then cooled to room temperature while allowing argon gas to flow at a flow velocity of 400 mL/min, and the quartz boat was removed to obtain a carbon material precursor in which the surface of the template material is covered with a carbonaceous layer. At this time, the template material was confirmed to be an agglomerate of a plurality of primary nanoparticles combined in a bead-chain-like configuration with a plurality of branching structures by electron microscopy.

### —Removal of Template Material—

Next, the template material was removed from the resulting carbon material precursor by the following operation to obtain a carbon material.
(1) The carbon material precursor was taken into a 100 mL PFA beaker, and ultrapure water was added thereto to the extent that the carbon material precursor was entirely wetted.
(2) After 46% hydrofluoric acid was added, the resultant was stirred for 2 hours with a stirrer.
(3) After the stirring was stopped, the resultant was left to stand until a sample precipitated.
(4) A PTFE membrane filter (φ 47 mm, pore size: 0.1 μm) was used to filtrate under suction from the supernatant.
(5) The sample on the filter paper was rinsed with about 39 mL of ultrapure water and filtrated under suction. These procedures were repeated 3 times.
(6) The sample on the filter paper was collected into the original PFA beaker.
(7) Operations (2) to (6) were repeated again.
(8) About 40 mL of ultrapure water was added thereto and the resultant was stirred for 1 hour with a stirrer.
(9) After the stirring was stopped, the resultant was left to stand until a sample precipitated.
(10) The supernatant was discarded, 5% caustic soda was added thereto, and the resultant was stirred for 12 hours while heated to 80° C.
(11) After the stirring was stopped, the resultant was left to stand until a sample precipitated.
(12) A PTFE membrane filter (47 mm, pore size: 0.1 μm) was used to filtrate under suction from the supernatant.
(13) The sample on the filter paper was rinsed with ultrapure water and filtrated under suction. These procedures were repeated until the filtrate became neutral.
(14) The sample on the filter paper was collected in a petri dish, and dried in a dryer at 110° C. for 8 hours.

### —Heat Treatment—

The resulting carbonaceous layer was placed in a rectangular high-temperature heating furnace (manufactured by IZUMI-TECH.), after reducing the pressure (on the order of 10⁻¹ Pa), heated to 1800° C. at a temperature rising rate of 15° C./min and calcined at this temperature for 1 hour while flowing argon gas (10 mL/min). The result was then cooled to room temperature to obtain Carbon material A.

### (Method for Measuring Oil Absorption of Carbon Material)

An oil absorption was measured for the resulting Carbon material A in accordance with “JIS K5101-13-1 Pigment test method—Part 13: Oil absorption-Section 1: Refined linseed oil method”. The result was shown in Table 1.

### (Observation by Transmission Electron Microscopy)

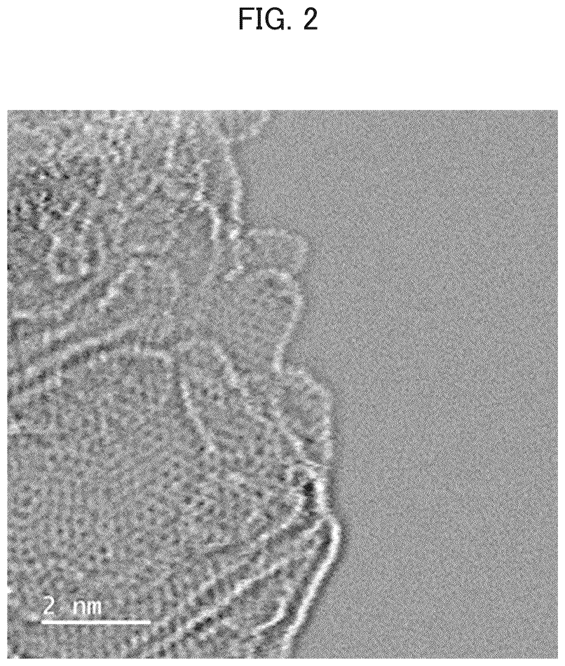

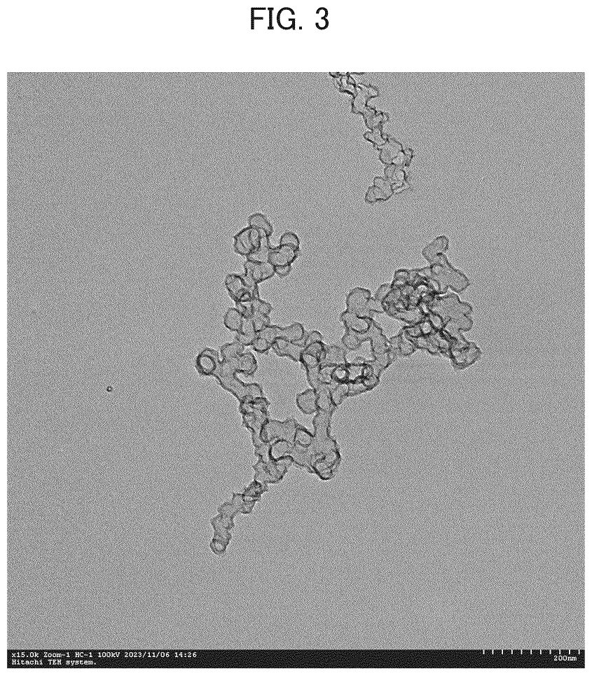

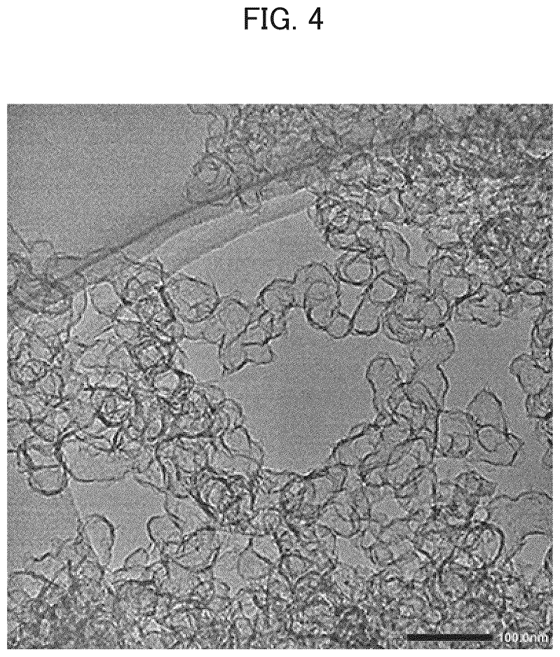

The resulting Carbon material A was observed for shape. FIG. 2 is an enlarged TEM image of Carbon material A of Example 1 as observed using a transmission electron microscope (TEM: Model JEM-ARM300F, manufactured by JEOL Ltd.) at an acceleration voltage of 80 kV. FIG. 3 is a TEM image of Carbon material A of Example 1 as observed using a transmission electron microscope (TEM: Model H-7650, Hitachi High-Tech Corporation) at an acceleration voltage of 100 kV. As shown in FIGS. 2 to 3, the surrounding wall of Carbon material A was confirmed to have a graphene structure composed of a six-membered carbon ring structure. It was also confirmed that Carbon material A of Example 1 has a combined structure composed of a plurality of hollow particulate parts combined together, each of the hollow particulate parts being composed of the surrounding wall with a plurality of pores.

### (Measurement of Nitrogen Adsorption/Desorption)

The resulting Carbon material A was measured for nitrogen adsorption/desorption using an automated specific surface area/pore size distribution analyzer (BELSORP MINI, manufactured by MicrotracBEL Corp.). A sample to be measured was dried under reduced pressure at 150° C. for 6 hours using BEL pre before measurement. From the resulting adsorption isotherm, the BET specific surface area was determined using the BET method. The BET method was applied in a range of P/P0=0.05 to 0.3. Based on the resulting adsorption/desorption isotherm, the total pore volume was measured by converting the nitrogen adsorption amount at −196° C. and relative pressure P/P0=0.99 into a volume of liquid nitrogen density. The results are shown in Table 1. The pore size distribution was determined by the BJH method.

### (Raman Spectrometry)

The resulting Carbon material A was subjected to Raman spectrometry using a microscopic Raman spectrometer (LabRAM HR-800, manufactured by HORIBA, Ltd.). The measurement was performed using a 532 nm laser, with a filter set to D1 and a hole set to 100 μm. The measurement range was 300 to 3500 cm⁻¹. Intensity ratios such as (I_{G}/I_{2D}), (I_{D}/I_{G}), etc., were calculated from the resulting Raman spectrum and shown in Table 1.

### (Production of Positive Electrode)

96.5% of a ternary positive electrode material NCM (LiNi_{0.5}Co_{0.2}Mn_{0.3}O₂, manufactured by Kelong) powder with an average particle size of 8 μm serving as active material, 0.5% by weight of Carbon material A obtained as described above and serving as an electrical conductive assistant, and 3% by weight of PVDF (manufactured by KUREHA CORPORATION) were added to N-methylpyrrolidone (NMP) serving as a solvent, and mixed together. Note that the electrical conductive assistant was a dispersion liquid of Carbon material A in the NMP solvent. The mixture of the active material, the electrical conductive assistant and the PVDF was taken into a planetary mixer, and the resultant was kneaded while NMP was added in plural times at a revolution speed of 2000 rpm until the resultant achieved a uniform and appropriate viscosity to produce a slurry for a positive electrode material. The slurry for a positive electrode material was applied to a 15-μm thick aluminum foil at a constant velocity using a doctor-blade coating device equipped with a micrometer. The resultant was then dried in a vacuum dryer set at 110° C. to obtain a positive electrode raw sheet. The positive electrode raw sheet was then punched out using a φ 15-mm punch-type punching machine, pressurized at 45 kN using a cylinder-type jig, and vacuum-dried at 120° C. to obtain a positive electrode to be assembled into a battery.

### (Production of Lithium Ion Battery)

In a glove box with an argon gas atmosphere, the positive electrode thereby produced and a metallic Li punched to φ 16 mm were used to sandwich a 25-μm thickness separator (polypropylene microporous membrane) so as to oppose the positive electrode composite layer and the metallic Li, a 1 M LiPF₆ solution (1:1 mixed solvent of ethylene carbonate (EC):diethyl carbonate (DEC)) was added as an electrolyte solution, and the resultant was caulked and sealed to produce a 2032 coin-type test battery. The test battery was then washed with ethanol and subjected to the below-described battery evaluation.

The produced test battery was used to evaluate the battery performance according to the following procedure to determine a 2C maintenance rate, a charge capacity, a discharge capacity, and a Coulomb efficiency.

### (Method for Evaluating Positive Electrode)

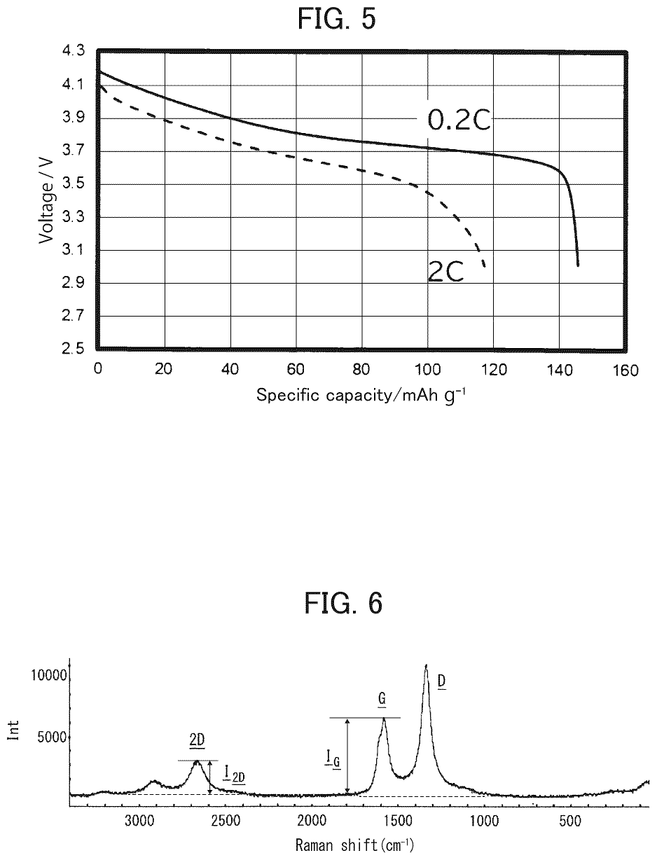

The test battery was applied with a constant current of 1.25 mA (equivalent to 0.2 C) per test battery up to 4.2 V, after reaching 4.2 V, charging was performed at a constant voltage and continued up to 0.31 mA (0.05 C). After that, discharging was then performed up to 3 V at a constant current of 1.25 mA. The charge capacity, discharge capacity, and average voltage at this time were determined, from which a Coulomb efficiency (discharge capacity divided by charge capacity) was calculated. Then, the same test battery as described above was applied with a constant current of 1.25 mA (equivalent to 0.2 C) per test battery up to 4.2 V, after reaching 4.2 V, charging was performed at a constant voltage and continued up to 0.31 mA (0.05 C). After that, discharging was then performed up to 3 V at a high rate, that is, a constant current of 12.5 mA (equivalent to 2C). A 2C maintenance rate (2C capacity divided by 0.2C capacity) of the test battery was determined from the resulting discharge capacity of the test battery. The results are shown in Table 1. FIG. 5 is a graph showing the discharge curves for different discharge current values using the test battery.

### Example 2

Carbon material B was obtained in the same manner as in Example 1, except that fumed silica (SiO₂/AEROSIL (registered trademark) R972, particle size: 25 nm, BET specific surface area: 111 m²/g, carbon content: 0.6 to 1.2%, manufactured by NIPPON AEROSIL CO., LTD.) was used as the raw material for a template material and the CVD reaction time was changed to 120 min, and a 2032 coin-type test battery was produced therefrom. It was confirmed by electron microscopy that the template material was confirmed to be an agglomerate of a plurality of primary nanoparticles combined in a bead-chain-like configuration with a plurality of branching structures. FIG. 6 shows the Raman spectrum of Carbon material B.

### Example 3

Carbon material C was obtained in the same manner as in Example 1, except that the CVD reaction time was changed to 75 minutes, and a 2032 coin-type test battery was produced therefrom.

### Example 4

Carbon material D was obtained in the same manner as in Example 1, except that the CVD reaction time was changed to 60 minutes, and a 2032 coin-type test battery was produced therefrom.

### Example 5

Carbon material E was obtained in the same manner as in Example 1, except that the CVD reaction time was changed to 40 minutes, and a 2032 coin-type test battery was produced therefrom.

### Example 6

Carbon material F was obtained in the same manner as in Example 1, except that the CVD reaction time was changed to 130 minutes, and a 2032 coin-type test battery was produced therefrom.

### Example 7

Carbon material G containing graphene was obtained in the same manner as in Example 1, except that alumina (Al₂O₃/PURALOX SBa200, particle size: 7 nm, BET specific surface area: 202 m²/g, manufactured by SASOL) was used as the raw material for the template material, and a 2032 coin-type test battery was produced therefrom.

### Example 8

Carbon material H was obtained in the same manner as in Example 1, except that magnesia (MgO/Kyowamag MF150, particle size: 30 nm, BET specific surface area: 129 m²/g, manufactured by Kyowa Chemical Industry Co., Ltd.) was used as the raw material for the template material and the template material was removed as described below, and a 2032 coin-type test battery was produced therefrom.

### (Removal of Template Material)

1 to 1.4 g of the carbon material precursor after the CVD reaction, about 100 g of hydrochloric acid (manufactured by FUJIFILM Wako Pure Chemical Corporation, 5 mol/L), and a stirrer bar were added to a Teflon (registered trademark) beaker and stirred at room temperature for 5 hours, the resultant was then washed 5 times with pure water while filtering the sample using a membrane filter (0.1 μm), and filtered by suction. At this time, sufficient care was taken so as not to dry out the deposit on the filter paper. The deposit was then placed into a glass beaker containing about 100 mL of acetone. The beaker was covered with aluminum foil, held in a vacuum dryer at a vacuum pressure of 0.06 MPa for 2 minutes, returned to normal pressure, and heated in a thermostatic bath at 60° C. for 10 minutes, thereby performing acetone substitution. The supernatant in the beaker was taken out by a pipette, and the same acetone substitution was performed again, followed by drying under reduced pressure at 150° C. for 6 hours to obtain Carbon material H.

### Example 9

Carbon material I was obtained in the same manner as in Example 1, except that no heat treatment was applied, and a 2032 coin-type test battery was produced therefrom.

### Comparative Example 1

A 2032 coin-type test battery was produced in the same manner as in Example 1, except that commercially available carbon black (DENKA BLACK Li-100: manufactured by Denka Company Limited) was used as the carbon material.

TABLE 1

| | | | Carbon material property | | | | | | | | |
|---|---|---|---|---|---|---|---|---|---|---|---|
| | | | | Specific | Total | | | Battery property | | | |
| | | | Oil | surface | pore | Lamination | Amorphous | 2 C | Charge | Discharge | Coulomb |
| | Carbon | Template | absorption | area | volume | index | index | maintenance | capacity | capacity | efficiency |
| | material | material | [mL/100 g] | [m²/g] | [cc/g] | I_{G}/I_{2D} | I_{D}/I_{G} | rate [%] | [mAh/g] | [mAh/g] | [%] |
| Example 1 | A | NX90G | 1889 | 906 | 4.34 | 1.79 | 1.79 | 79 | 165 | 145 | 87.9 |
| Example 2 | B | R972 | 2201 | 899 | 3.47 | 1.74 | 1.40 | 75 | 162 | 142 | 87.7 |
| Example 3 | C | NX90G | 1678 | 1020 | 5.35 | 1.67 | 1.69 | 79 | 167 | 146 | 87.4 |
| Example 4 | D | NX90G | 1140 | 946 | 5.62 | 1.43 | 1.70 | 75 | 160 | 140 | 87.5 |
| Example 5 | E | NX90G | 703 | 986 | 2.95 | 1.20 | 1.68 | 62 | 151 | 130 | 86.1 |
| Example 6 | F | NX90G | 2280 | 817 | 3.81 | 2.08 | 1.59 | 74 | 166 | 146 | 88.0 |
| Example 7 | G | Al₂O₃ | 430 | 1747 | 2.40 | 0.73 | 1.59 | 39 | 121 | 71 | 58.4 |
| Example 8 | H | MgO | 492 | 1032 | 1.98 | 0.86 | 1.00 | 45 | 149 | 127 | 85.7 |
| Example 9 | I | NX90G | 2297 | 1145 | 6.03 | 3.57 | 1.72 | 74 | 164 | 141 | 86.5 |
| Comparative | DB Li- | — | 303 | 65 | 0.26 | 2.07 | 1.01 | 19 | 146 | 122 | 83.6 |
| Example 1 | 100 | | | | | | | | | | |

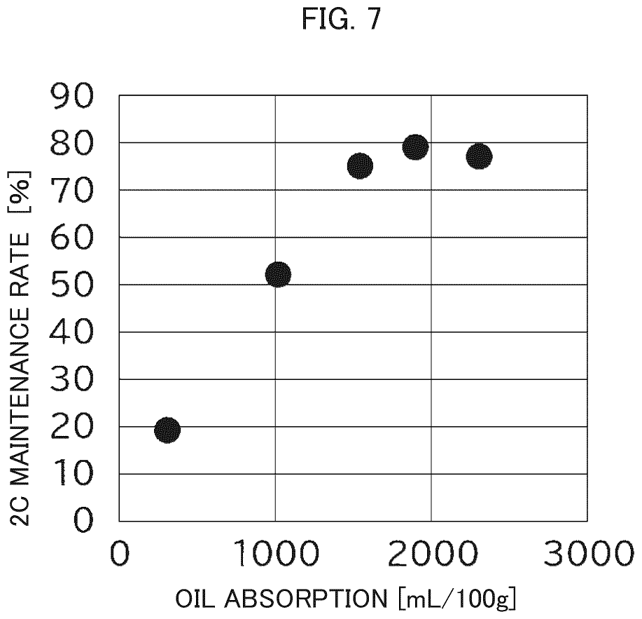

FIG. 7 is a graph showing a relationship between the oil absorption and the 2C maintenance rate for the test batteries of Examples 1 and 9 and Comparative Example 1. The vertical axis represents the 2C maintenance rate and the horizontal axis represents the oil absorption. It can be seen from Table 1 and FIG. 7 that Carbon materials A to I satisfying the predetermined configuration are highly superior for the 2C maintenance rate (rapid chargeability), the charge capacity, the discharge capacity, and the Coulomb efficiency among battery properties (comparing Examples 1 to 9 with Comparative Example 1).

Among these, the test batteries using Carbon materials A to F of Examples 1 to 6 all have highly enhanced initial capacity (charge capacity) and Coulomb efficiency. Although it could not be determined which property of the carbon material is responsible for such a difference in battery performance, it is believed to be affected by I_{G}/I_{2D} and I_{D}/I_{G} as measured by the Raman spectrometry relating to the pore shape.

As for the oil absorption, even acetylene black (Comparative Example 1) that is considered to have a high oil absorption among carbon materials has the oil absorption of only about 300 mL/100 g. In contrast, Carbon materials A to I of Examples 1 to 9 have the oil absorption of greater than 400 mL/100 g, and some of them have the oil absorption of greater than 700 mL/100 g, which is difficult to achieve with ordinary carbon materials, and even greater than 2000 mL/100 g, indicating that they are new carbon materials. It is believed that Carbon materials A to I can absorb more oil because the interior space of the carbon material of the present invention is larger than fine voids inside acetylene black.

The 2C maintenance rate of the battery performance is an evaluation item to determine a possibility of rapid discharge of the battery, and Carbon materials A to I have been found to have a high 2C maintenance rate. The 2C maintenance rate of the battery performance has also been found to be highly correlated with the oil absorption rate of the carbon material. The 2C maintenance rate has also been found to become larger in a range of the oil absorption of the carbon material of more than 400 mL/g to around 1000 mL/g, and thereafter, peaked around 1600 to 1900 mL/g. The structure of the carbon material of the present invention with such a large oil absorption may indicate that a total pore volume is large, and that a certain number of graphene layers is required by increasing the I_{D}/I_{G} to some extent (D band refers to a sp3 orbital when a crystal structure of graphene composed of a sp2 orbital is disrupted, and a larger D band distorts the space) in order to create large pores and by increasing the I_{G}/I_{2D} called the lamination index in order to maintain the large pores.

### Experiment 2: Verification of Basic Physical Property of Carbon Material (Comparison of Oil Absorption by Different Measurement Methods)

### Comparative Examples 2 to 4

Three types of carbon black each having an oil absorption as specified in JIS K6217-4 described in catalog were measured for oil absorption in accordance with JIS K5101-13-1, and the results are shown in Table 2. There was no great difference in the oil absorption between the two measurement methods.

TABLE 2

| | | Oil | |
|---|---|---|---|
| | | absorption | Catalog |
| | Carbon black | [mL/100 g] | value |
| Comparative | # 4000B (manufactured by | 108 | 102 |
| Example 2 | Mitsubishi Chemical Group | | |
| | Corporation) | | |
| Comparative | Asahi Thermal (Asahi Carbon Co., | 34 | 29 |
| Example 3 | Ltd.) | | |
| Comparative | BP2000 (manufactured by Cabot | 329 | 330 |
| Example 4 | Corporation) | | |

### Experiment 3: Verification of Basic Performance of Carbon Material (Comparison of Performance of Batteries with Different Amounts of Carbon Materials Added to Electrodes)

### Example 10

A test battery was produced under the same conditions as in Example 1, except that the amount of Carbon material A was changed to 0.3% by weight and the amount of the positive electrode material NCM was changed to 96.7% in the production of the positive electrode.

### Example 11

A test battery was produced under the same conditions as in Example 1, except that the amount of Carbon material A was changed to 1.0% by weight and the amount of the positive electrode material NCM was changed to 96.0% in the production of the positive electrode.

### Example 12

A test battery was produced under the same conditions as in Example 1, except that the amount of Carbon material A was changed to 2.0% by weight and the amount of the positive electrode material NCM was changed to 95.0% in the production of the positive electrode.

### Example 13

A test battery was produced under the same conditions as in Example 1, except that the amount of Carbon material A was changed to 3.0% by weight and the amount of the positive electrode material NCM was changed to 94.0% in the production of the positive electrode.

### Example 14

A test battery was produced under the same conditions as in Example 1, except that the amount of Carbon material A was changed to 4.0% by weight and the amount of the positive electrode material NCM was changed to 93.0% in the production of the positive electrode.

### Example 15

A test battery was produced under the same conditions as in Example 1, except that the amount of Carbon material A was changed to 6.0% by weight and the amount of the positive electrode material NCM was changed to 91.0% in the production of the positive electrode.

### Example 16

A test battery was produced under the same conditions as in Example 1, except that the amount of Carbon material A was changed to 0.1% by weight and the amount of the positive electrode material NCM was changed to 96.9% in the production of the positive electrode.

The test batteries of Examples 10 to 16 were measured for the 2C maintenance rate, the charge capacity, the discharge capacity, and the Coulomb efficiency in the same manner as in Example 1. The results are shown in Table 3.

TABLE 3

| | | | | Battery property | | | |
|---|---|---|---|---|---|---|---|
| | | Oil | Blended | 2 C | Charge | Discharge | Coulomb |
| | Carbon | absorption | amount | maintenance | capacity | capacity | efficiency |
| | material | [mL/100 g] | [wt %] | rate [%] | [mAh/g] | [mAh/g] | [%] |
| Example 10 | A | 1889 | 0.3 | 63 | 157 | 133 | 84.7 |
| Example 1 | A | 1889 | 0.5 | 79 | 165 | 145 | 87.9 |
| Example 11 | A | 1889 | 1 | 90 | 167 | 148 | 88.6 |
| Example 12 | A | 1889 | 2 | 95 | 167 | 147 | 88.0 |
| Example 13 | A | 1889 | 3 | 94 | 166 | 146 | 88.0 |
| Example 14 | A | 1889 | 4 | 93 | 165 | 140 | 84.8 |
| Example 15 | A | 1889 | 6 | 90 | 163 | 128 | 78.5 |
| Example 16 | A | 1889 | 0.1 | 28 | 154 | 129 | 77.3 |
| Comparative | DB Li-100 | 303 | 0.5 | 19 | 146 | 122 | 83.6 |
| Example 1 | | | | | | | |

FIG. 8 is a graph showing a relationship of the amount of the carbon material with the 2C maintenance rate and the discharge capacity for test batteries of Examples 1 and 10 to 16. The left vertical axis represents the 2C maintenance rate, the right vertical axis represents the discharge capacity, and the horizontal axis represents the amount of the carbon material. In FIG. 8, the black circle indicates the 2C maintenance rate and the white triangle indicates the discharge capacity. It could be confirmed from Table 3 and FIG. 8 that the test batteries had a good high-rate property in the range of the amount of the carbon material in Examples 1 and 10 to 16. It was found that the battery properties were able to be particularly highly improved in the Examples in which the amount of the carbon material was in the ranges of 0.5 to 4.0% by weight and 1.0 to 4.0% by weight. A larger amount of the carbon material increased the charge/discharge capacity of the battery, but an excessively large amount of the carbon material was believed to reduce the content of the active material, and thus the charge/discharge capacity of the electrode was reduced.

### Experiment 4: Analysis of Carbon Material by Nitrogen Adsorption/Desorption Measurement (Comparison of Specific Surface Area, Pore Volume, Etc., with Those of Other Carbon Materials)

### (Measurement of Nitrogen Adsorption/Desorption)

Carbon materials A to I used in Examples 1 to 9 and carbon black (DENKA BLACK Li-100: manufactured by Denka Company Limited) used in Comparative Example 1 were subjected to the nitrogen adsorption/desorption measurement using the above-described method.

The BET specific surface area, the mode pore size, the total pore volume (P/P0=0.99), the micropore volume (P/P0=0.1 or less), the mesopore volume (P/P0=0.1 to 0.96), 2 to 10 nm mesopore volume (P/P0=0.1 to 0.79), 10 to 50 nm mesopore volume (P/P0=0.79 to 0.96), and a macropore volume (P/P0=0.96 to 0.99) were determined from the resulting adsorption/desorption isotherms. The average pore size d was determined according to d=4V/S in which S is the BET specific surface area and V is the total pore volume, assuming that the pores were cylinder-shaped. The results are shown in Table 4. Note that, in Comparative Example 1, the column “mode pore size” is marked “-” because it does not have a peak in the pore size distribution.

### Comparative Examples 5 and 6

In addition to the above carbon materials, the nitrogen adsorption/desorption measurement was also performed on the following carbon materials. The results are shown in Table 4. Note that, in Comparative Example 5, the column “mode pore size” is marked “-” because it does not have a peak in the pore size distribution, similarly to Comparative Example 1.
Comparative Example 5: Graphite (KS6, manufactured by Imerys S.A.)
Comparative Example 6: Activated carbon (YP-5, manufactured by Kuraray Co., Ltd.)

TABLE 4

| | | Oil | Specific | Mode pore | Total pore | Micropore | Mesopore | Macropore | Average |
|---|---|---|---|---|---|---|---|---|---|
| | Carbon | absorption | surface area | size | volume | volume | volume | volume | pore size |
| | material | [mL/100 g] | [m²/g] | [nm] | [cc/g] | [cc/g] | [cc/g] | [cc/g] | [nm] |
| Example 1 | A | 1889 | 906 | 23.8 | 4.34 | 0.34 | 2.77 | 1.23 | 19.1 |
| Example 2 | B | 2201 | 899 | 15.8 | 3.47 | 0.33 | 2.13 | 1.01 | 15.4 |
| Example 3 | C | 1678 | 1020 | 23.0 | 5.35 | 0.31 | 3.05 | 1.99 | 21.0 |
| Example 4 | D | 1140 | 946 | 21.3 | 5.62 | 0.36 | 2.85 | 2.41 | 23.8 |
| Example 5 | E | 703 | 986 | 16.2 | 2.95 | 0.35 | 2.65 | 0.48 | 12.0 |
| Example 6 | F | 2280 | 817 | 24.4 | 3.81 | 0.31 | 2.34 | 1.18 | 18.7 |
| Example 7 | G | 430 | 1747 | 6.6 | 2.40 | 0.60 | 1.73 | 0.07 | 5.5 |
| Example 8 | H | 492 | 1032 | 9.6 | 1.98 | 0.36 | 1.58 | 0.04 | 7.7 |
| Example 9 | I | 2297 | 1145 | 28.8 | 6.03 | 0.42 | 3.04 | 2.57 | 21.1 |
| Comparative | DB Li-100 | 303 | 65 | — | 0.26 | 0.03 | 0.11 | 0.12 | 15.8 |
| Example 1 | | | | | | | | | |
| Comparative | KS6 | 63 | 19 | — | 0.11 | 0.01 | 0.04 | 0.06 | 23.5 |
| Example 5 | | | | | | | | | |
| Comparative | YP-50F | 160 | 1693 | 0.9 | 0.79 | 0.65 | 0.12 | 0.02 | 1.9 |
| Example 6 | | | | | | | | | |

Furthermore, the ratios of the micropore volume, the mesopore volume, and the macropore volume in the total pore volume, and the ratios of the 2 to 10 nm mesopore volume and the 10 to 50 nm mesopore volume in the total pore volume were calculated and are shown in Table 5.

TABLE 5

| | | | N₂ adsorption | | | | | |
|---|---|---|---|---|---|---|---|---|
| | | Oil | Specific | Mode pore | Total pore | Ratio of pore (%) | | |
| | Carbon | absorption | surface area | size | volume | Micropore | Mesopore | Macropore |
| | material | [mL/100 g] | [m²/g] | [nm] | [cc/g] | [%] | [%] | [%] |
| Example 1 | A | 1889 | 906 | 23.8 | 4.34 | 8 | 64 | 28 |
| Example 2 | B | 2201 | 899 | 15.8 | 3.47 | 9 | 62 | 29 |
| Example 3 | C | 1678 | 1020 | 23.0 | 5.35 | 6 | 57 | 37 |
| Example 4 | D | 1140 | 946 | 21.3 | 5.62 | 6 | 51 | 43 |
| Example 5 | E | 703 | 986 | 16.2 | 2.95 | 12 | 72 | 16 |
| Example 6 | F | 2280 | 817 | 24.4 | 3.81 | 8 | 61 | 31 |
| Example 7 | G | 430 | 1747 | 6.6 | 2.40 | 25 | 72 | 3 |
| Example 8 | H | 492 | 1032 | 9.6 | 1.98 | 18 | 80 | 2 |
| Example 9 | I | 2297 | 1145 | 28.8 | 6.03 | 7 | 50 | 43 |
| Comparative | DB Li-100 | 303 | 65 | — | 0.26 | 11 | 44 | 45 |
| Example 1 | | | | | | | | |
| Comparative | KS6 | 63 | 19 | — | 0.11 | 6 | 37 | 57 |
| Example 5 | | | | | | | | |
| Comparative | YP-50F | 160 | 1693 | 0.9 | 0.79 | 82 | 15 | 3 |
| Example 6 | | | | | | | | |

Table 4 shows that Carbon materials A to I of the present invention are characterized by a large BET specific surface area (817 to 1747 m²/g) and a large total pore volume (1.98 cc/g or more) (Examples 1 to 9). On the other hand, for Comparative Examples 1, 5, and 6, only the activated carbon of Comparative Example 6 has a specific surface area of 400 m²/g or more or 800 m²/g or more, but the total pore volume of the activated carbon of Comparative Example 6 is small of 1.00 cc/g or less. Comparative Examples 1, 5, and 6 did not have both a large specific surface area and a large total pore volume.

It can also be found that Carbon materials A to I of the present invention are very different in the mode pore size and the macropore volume. Carbon materials A to F and I have larger mode pore sizes (peak top pore sizes) than those of Carbon materials G to H (compare Examples 7 to 8 with Examples 1 to 6 and 9). In other words, Carbon materials A to F and I have larger pores than those of Carbon materials G to H, which may have resulted in the difference in the oil absorption. Carbon materials A to F and I were found to have larger macropore volumes than those of the other carbon materials. In particular, Carbon materials G and H of Examples 7 to 8 have almost no macropore volume.

From Table 5, it is found that the ratio of the macropore volume to the total pore volume is 16 to 43% for Carbon materials A to F and I, but only 2 to 3% for Carbon materials G to H of Examples 7 to 8. The graphite of Comparative Example 5 has a high ratio of macropore volume, but a small specific surface area being 19 m²/g.

When the mesopore volume is divided into 2 to 10 nm mesopore volume and 10 to 50 nm mesopore volume, Carbon materials A to F and I are found to be biased toward the 10 to 50 nm mesopore volume.

From Tables 4 and 5, it is found that Carbon materials A to F and I are carbon materials with unique porosity, that is, a large mode pore size, a large specific surface area, a large total pore volume, a large 10 to 50 nm pore volume, and a large macropore volume.

### Experiment 5: Structural Analysis of Carbon Layer in Carbon Material (X-Ray Analysis of Carbon Layer in Carbon Material Produced in Example)

### (XRD Measurement)

The carbon materials were subjected to X-ray diffraction (XRD) measurement using an X-ray diffractometer (Miniflex 600, manufactured by Rigaku Holdings Corporation). A Si non-reflective plate was used as a sample stand, and a measurement sample was placed on a circular portion of the sample stand and measured under the following measurement conditions. Values of d002, Lc(002), and La(10) are shown in Table 6.
X-ray source: CuKa
Tube voltage: 40 kV
Tube current: 15 mA
Measuring angle: 5 to 90 degrees
Scanning speed: 2 deg/min
Scanning axis: 2θ/θ

TABLE 6

| | | Oil | | | | | |
|---|---|---|---|---|---|---|---|
| | | absorp- | | | | | |
| | | tion | | | XRD | | |
| | Carbon | [mL/ | I_{G}/ | I_{D}/ | d002 | Lc(002) | La(10) |
| | material | 100 g] | I_{2D} | I_{G} | [Å] | [nm] | [nm] |
| Example 1 | A | 1889 | 1.79 | 1.79 | 3.53 | 1.21 | 1.82 |
| Example 2 | B | 2201 | 1.74 | 1.40 | 3.73 | 1.13 | 2.82 |
| Example 3 | C | 1678 | 1.67 | 1.69 | 3.69 | 1.18 | 3.78 |
| Example 4 | D | 1140 | 1.43 | 1.70 | 3.39 | 1.15 | 3.47 |
| Example 5 | E | 703 | 1.20 | 1.68 | 3.42 | 1.12 | 3.24 |
| Example 6 | F | 2280 | 2.08 | 1.59 | 3.53 | 1.19 | 2.40 |
| Example 7 | G | 430 | 0.73 | 1.59 | 3.43 | 1.66 | 2.82 |
| Example 8 | H | 492 | 0.86 | 1.00 | 3.37 | 1.74 | 3.80 |
| Example 9 | I | 2297 | 3.57 | 1.72 | 3.56 | 1.02 | 2.00 |
| Comparative | DB Li- | 303 | 2.07 | 1.01 | 3.45 | 3.53 | 3.03 |
| Example 1 | 100 | | | | | | |
| Comparative | KS6 | 63 | 2.35 | 0.19 | 3.36 | 27.5 | 6.11 |
| Example 5 | | | | | | | |
| Comparative | YP-50F | 160 | 3.02 | 1.11 | 3.49 | 0.39 | 1.64 |
| Example 6 | | | | | | | |

The Lc (002) to be measured by XRD refers to a distance of a crystalline structure part, and a larger Lc (002) indicates a higher crystallinity. In other words, Carbon materials A to I have a small Lc(002). This indicates that the carbonaceous layer in the carbon material of the present invention has a crystallinity that is not so high. The D band in a Raman spectrum is a band representing the sp3 bond (C—H stretching motion) in the carbon material, which increases when the sp2 bond in the six-membered carbon ring structure of the carbon layer is cleaved to form the sp3 bond. Therefore, the carbon layers in Carbon materials A to I of the present invention consist of a mixture of crystalline and amorphous phases, which is believed to be attributed to the formation of a large space.

### Experiment 6: Determination of Number of Carbon Layers of Carbon Material (Study of Relationship Among Number of Carbon Layers, Pore Size, and Oil Absorption)

### (Number of Carbon Layers)

The number of carbon layers was calculated from a weight reduction ratio of carbon during the production of Examples 1 to 9, and the results are shown in Table 7.

Specifically, TGA measurement was performed to determine the number of carbon layers. The TG measurement was performed using STA-2500 (NETZSCH) by heating up to 900° C. at a temperature rising rate of 5° C./min, and then cooling down at a cooling rate of 20° C./min under a flow of argon gas (80 mL/min) and oxygen (20 mL/min). The result of a blank measurement performed under the same temperature profile conditions using an empty pan was subtracted. The pan used was an alumina pan. The number of carbon layers was calculated from the weight reduction ratio (%) of carbon determined by the TG measurement as follows. The weight of the carbon layer was calculated from the weight reduction ratio of carbon, and the weight of the carbon layer per area was calculated from the weight of the carbon layer and the surface area of the template material. The weight of the carbon layer per area of the template material was then divided by the weight of the carbon layer per area of single-layer graphene (7.61×10⁻⁴ g/m²) to calculate the number of carbon layers.

TABLE 7

| | | | | CVD | | | | |
|---|---|---|---|---|---|---|---|---|
| | | Template material | | Methane | | | | Oil |
| | Carbon | | Item | concentration | Temperature | Time | Number of | absorption |
| | material | Compound | number | [%] | [° C.] | [min] | layers | [mL/100 g] |
| Example 1 | A | SiO₂ | NX90G | 20 | 900 | 90 | 3.5 | 1889 |
| Example 2 | B | SiO₂ | R972 | 20 | 900 | 120 | 3.9 | 2201 |
| Example 3 | C | SiO₂ | NX90G | 20 | 900 | 75 | 3.0 | 1678 |
| Example 4 | D | SiO₂ | NX90G | 20 | 900 | 60 | 2.5 | 1140 |
| Example 5 | E | SiO₂ | NX90G | 20 | 900 | 40 | 1.9 | 703 |
| Example 6 | F | SiO₂ | NX90G | 20 | 900 | 130 | 4.5 | 2280 |
| Example 7 | G | Al₂O₃ | SBa200 | 20 | 900 | 120 | 1.5 | 430 |
| Example 8 | H | MgO | MF150 | 20 | 900 | 120 | 1.9 | 492 |
| Example 9 | I | SiO₂ | NX90G | 20 | 900 | 90 | 3.5 | 2297 |

It was confirmed from Table 7 that, for Carbon materials A to I of the present invention, the carbon materials with different properties can be obtained by controlling the number of carbon layers so as to fall within a predetermined range. It has also been found that the number of carbon layers is correlated with the oil absorption of the carbon material since the oil absorption rapidly increased as the number of carbon layers increased (Examples 1 to 9).

Among these, as shown in Tables 5 and 7, Carbon materials A to F and I with 1.9 to 4.5 carbon layers showed high oil absorption with a high 10 to 50 nm mesopore volume and a high 50 nm or more macropore volume.

### Experiment 7: Analysis of Particulate Structure of Carbon Material (Particle Size Distribution Measurement and TEM Image Analysis)

### (Measurement of Particle Size Distribution)

The agglomeration state of the carbon material was examined by measuring the particle size distribution using a laser diffraction particle size analyzer (MT3300 EXII-SDC, manufactured by MicrotracBEL Corp.). A measurement sample was the un-pulverized carbon material which had been immersed in ethanol for 9 minutes under a static condition. The D50, D10, D90, D90/D10, and D90/M×1000 in the particle size distribution curve were determined, and the results are shown in Table 8.

TABLE 8

| | | Oil | Mode pore | | | | | |
|---|---|---|---|---|---|---|---|---|
| | Carbon | absorption | size | D10 | D50 | D90 | | (D90/ |
| | material | [mL/100 g] | M [nm] | [μm] | [μm] | [μm] | D90/D10 | M × 1000) |
| Example 1 | A | 1889 | 23.8 | 12.0 | 30.3 | 49.3 | 4.1 | 2.1 |
| Example 2 | B | 2201 | 15.8 | 11.0 | 28.0 | 45.0 | 4.1 | 2.8 |
| Example 3 | C | 1678 | 23.0 | 12.5 | 35.0 | 52.0 | 4.2 | 2.3 |
| Example 4 | D | 1140 | 21.3 | 14.5 | 40.0 | 53.0 | 3.7 | 2.5 |
| Example 5 | E | 703 | 16.2 | 13.0 | 45.0 | 55.0 | 4.2 | 3.4 |
| Example 6 | F | 2280 | 24.4 | 12.0 | 26.0 | 45.0 | 3.8 | 1.8 |
| Example 7 | G | 430 | 6.6 | 18.9 | 38.9 | 79.0 | 4.2 | 12.1 |
| Example 8 | H | 492 | 9.6 | 15.0 | 65.1 | 179.6 | 12.0 | 18.7 |
| Example 9 | I | 2297 | 28.8 | 3.3 | 5.4 | 11.1 | 3.3 | 0.4 |
| Comparative | DB Li-100 | 303 | — | 6.0 | 24.1 | 70.0 | 11.6 | — |
| Example 1 | | | | | | | | |
| Comparative | KS6 | 63 | — | 2.2 | 3.6 | 5.7 | 2.6 | — |
| Example 5 | | | | | | | | |
| Comparative | YP-50F | 160 | 0.9 | 3.2 | 6.0 | 9.8 | 3.0 | 10.8 |
| Example 6 | | | | | | | | |

It can be seen from Table 8 that Carbon materials A to I all have D50 falling within a predetermined range. This indicates that the agglomeration force of the measurement sample is not so high since the measurement sample was one that was un-pulverized and just immersed in the solvent under a static condition. Furthermore, for Carbon materials A to F and I, although only the (D90/M×1000) is shown in Table 8, values obtained by dividing a cumulative particle size determined based on the particle size distribution by the mode pore size (M) in the pore size distribution measurement and then dividing the resulting value by 1000 ((D10/M×1000), (D50/M×1000), (D90/M×1000)) are all very small, indicating a weak agglomeration force (compare Examples 1 to 6 and 9 with Comparative Examples 1, 5, and 6).

### Experiment 8: Measurement of Desorbed Gas and Combustion Temperature of Carbon Material (Estimation of Stability of Carbon Material when being Used in Battery Application)

### (Thermal Desorption Spectrometry)

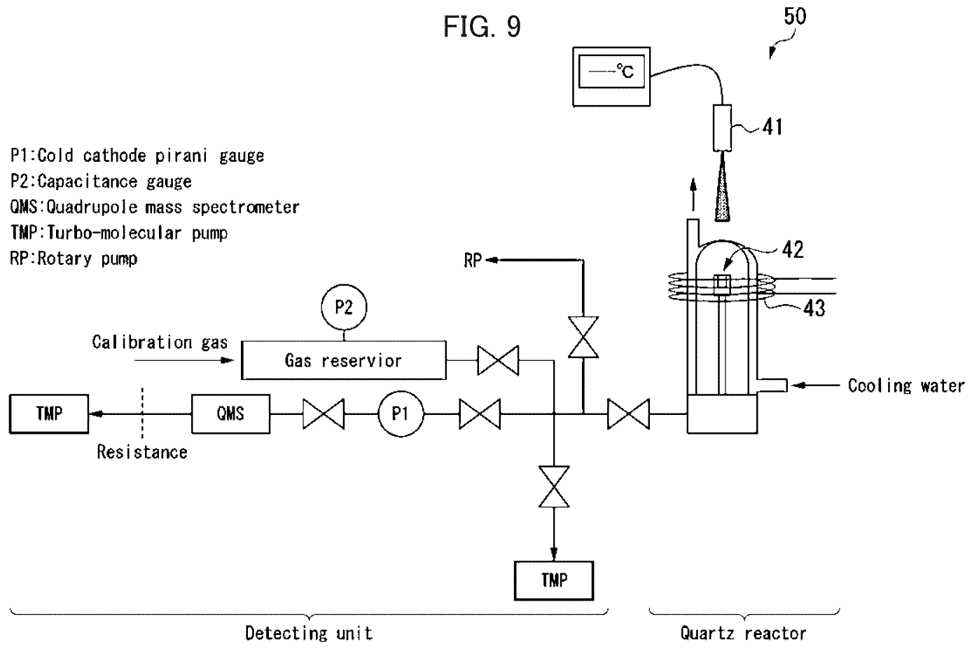

An ultra-sensitive vacuum TPD apparatus (developed at Tohoku University, T. Ishii et al., CARBON 80, 2014, 135-145) having the configuration shown in FIG. 9 was used for accurate qualitative and quantitative analyses of the oxygen-containing functional group and the hydrogen-terminated edge site. More specifically, 1 to 3 mg of the carbon material was placed on a graphite sample stand, and heated to 1800° C. at a temperature rising rate of 10° C./min under vacuum, and gases released during heating were analyzed by mass spectrometry to accurately qualitatively and quantitatively analyze the oxygen-containing functional group and the hydrogen-terminated edge site. A device 50 includes a quartz reactor having a radiation thermometer 41, a sample holder 42, and a high frequency induction coil 43, as well as a detection unit that connects to the quartz reactor. The detection unit includes a gas reservoir, a turbo molecular pump TMP, a rotary pump RP, a cold negative electrode pirani gauge P1, and a capacitance gauge P2.

### (Measurement of Combustion Temperature)

The combustion temperature of the carbon material was defined as the temperature at which a weight is decreased to 90% of the initial weight as determined by the combustion oxidation test under air flowing and the temperature rising rate of 5° C./min using a thermogravimetric analyzer. The combustion temperature of 550° C. or more was considered good.

The desorbed gas and the combustion temperature of the carbon material were examined, and the results are shown in Table 9.

TABLE 9

| | | TPD | | | | | Combustion |
|---|---|---|---|---|---|---|---|
| | Carbon | Total Gas | H | O | S_{edge} | | temperature |
| | material | [μmol/g] | [%] | [%] | [m²/g] | O/C | [° C.] |
| Example 1 | A | 60 | 0.002 | 0.07 | 4.2 | 0.001 | 636 |
| Example 2 | B | 45 | 0.001 | 0.043 | 3.1 | 0.000 | 610 |
| Example 3 | C | 170 | 0.004 | 0.161 | 11.5 | 0.002 | 626 |
| Example 4 | D | 194 | 0.004 | 0.215 | 12.3 | 0.002 | 622 |
| Example 5 | E | 218 | 0.006 | 0.228 | 15.9 | 0.002 | 605 |
| Example 6 | F | 139 | 0.003 | 0.143 | 8.9 | 0.001 | 625 |
| Example 7 | G | 100 | 0.003 | 0.105 | 7 | 0.001 | 630 |
| Example 8 | H | 110 | 0.003 | 0.115 | 7.5 | 0.001 | 638 |
| Example 9 | I | 1576 | 0.054 | 1.241 | 125 | 0.013 | 566 |
| Comparative | DB Li-100 | 2322 | 0.032 | 2.953 | 149.1 | 0.031 | 575 |
| Example 1 | | | | | | | |
| Comparative | KS6 | 76 | 0.001 | 0.08 | 4.8 | 0.001 | 806 |
| Example 5 | | | | | | | |
| Comparative | YP-50F | 3425 | 0.119 | 2.04 | 285.6 | 0.021 | 555 |
| Example 6 | | | | | | | |

It could be confirmed from the results shown in Table 9 that the oxygen content, O/C, total gas content, and edge content of the carbon material of the present invention are sufficiently low as determined by TPD-MS measurement. It has also been confirmed that the carbon material of the present invention has a sufficiently high combustion temperature.

### (Apparent Density)

For each carbon material, the apparent density was calculated from Expression (5) below using the total pore volume and the true density.

$$Apparent density ( g / cc ) = 1 / ( Total pore volume + ( 1 / True density ) ) \qquad Expression ( 5 )$$

Note that the total pore volume (cc/g) was a value calculated at P/P0=0.99 and the true density of graphite, 2.2 g/cc, was used as the true density. The results are shown in Table 10.

TABLE 10

| | | Apparent density |
|---|---|---|
| | Carbon material | [g/cc] |
| Example 1 | A | 0.209 |
| Example 2 | B | 0.255 |
| Example 3 | C | 0.172 |
| Example 4 | D | 0.165 |
| Example 5 | E | 0.294 |
| Example 6 | F | 0.234 |
| Example 7 | G | 0.351 |
| Example 8 | H | 0.411 |
| Example 9 | I | 0.154 |
| Comparative Example 1 | DB Li-100 | 1.401 |
| Comparative Example 5 | KS6 | 1.768 |
| Comparative Example 6 | YP-50F | 0.806 |

It could be confirmed from the results shown in Table 10 that the carbon materials of the present invention have a lower apparent density than those of Comparative examples, and that the apparent density is preferably 2.000 g/cc or less, and is preferred in the order of 1.500 g/cc or less, 1.000 g/cc or less, 0.500 g/cc or less, and 0.300 g/cc or less, and is preferred in the order of 0.050 g/cc or more, 0.100 g/cc or more, and 0.150 g/cc or more.

### Experiment 9: Investigation of Negative Electrode Containing Carbon Material

### Example 17

A negative electrode test battery was produced by changing the amount of the carbon material added to the negative electrode in Example 1 to 0.5% by weight. A negative electrode agent paste was produced by stirring and mixing 97% by weight of artificial graphite, 1% by weight of the carbon material of Example 1, 1% by weight of carboxymethyl cellulose, and 1% by weight of a styrene-butadiene rubber (SBR) in distilled water serving as a solvent so as to be uniform. The resulting paste was applied onto a 20 μm thickness copper foil, dried at 110° C., punched out to ¢ 15 mm, and pressurized at 30 kN to produce a negative electrode.

The resulting negative electrode was vacuum-dried at 120° C., and then placed in a glove box with an argon gas atmosphere, where a 2032 coin-type test battery in which a counter electrode was metallic Li was produced using a 1 M LiPF₆ solution (1:1 mixed solvent of ethylene carbonate (EC):diethyl carbonate (DEC)) serving as an electrolyte solution and a polypropylene separator.

The test battery was applied with a constant current of 1.23 mA (equivalent to 0.2C) per test battery up to 0 V, after reaching 0 V, charging was performed at a constant voltage and continued up to 0.31 mA (0.05C). After that, discharging was then performed up to 1.5 V at a constant current of 1.23 mA. The discharge capacity at this time was determined. Then, the same test battery as described above was applied with a constant current of 1.23 mA (equivalent to 0.2C) per test battery up to 0 V, after reaching 0 V, charging was performed at a constant voltage and continued up to 0.31 mA (0.05C). After that, discharging was then performed up to 1.5 V at a high rate, that is, a constant current of 12.3 mA (equivalent to 2C). The 2C maintenance rate (2C capacity divided by 0.2C capacity) was determined from the discharge capacity of the test battery determined in the above evaluation test.

The resulting negative electrode battery was evaluated and found to have a maintenance rate of 0.47 at 2C discharge.

### Comparative Example 7

A negative electrode test battery was produced in the same manner as in Example 17, except that acetylene black (product name: DENKA BLACK, manufactured by Denka Company Limited) was used as the electrical conductive assistant instead of the carbon material of Example 1 and the amount of this electrical conductive assistant added to the negative electrode was 1.0% by weight.

The resulting negative electrode battery was evaluated and found to have a maintenance rate of 0.16 at 2C discharge.

As is evident from the above Examples, the 2C maintenance rates for batteries using the carbon materials according to the present embodiment are higher than those of the batteries in Comparative Examples. The reason for this is that the carbon materials according to the present embodiment have high electron conductivity. In other words, this is because the carbon material according to the present embodiment has the surrounding wall with the graphene crystal structure and has the space that can hold an electrolyte solution within a hollow particulate part, unlike the electrical conductive assistants used in Comparative Examples. The discharge reaction is a reaction in which lithium ions desorbed upon charging returns to the positive electrode material. When discharge begins, electrons flow from an external circuit to the positive electrode, and the electrons and the lithium ions return to crystal structure sites of the positive electrode as a state that the electrons bond to the lithium ions, thereby restoring the bonding state before charging. In other words, the bonding of the lithium ion and the electron occurs simultaneously with the phase change in the crystal structure of the positive electrode. The phase change can be observed from the change in voltage. The “simultaneity” of the phase change is important with respect to the high maintenance rate upon a high rate discharge, and it could be confirmed that the carbon material of the present example is capable of achieving this “simultaneity”.

### Experiment 10: Investigation of Semi-Solid Electrolyte Battery

### Example 18

A battery including the positive electrode of Example 1 and the negative electrode of metallic Li was produced using a gel electrolyte instead of an electrolyte solution (liquid electrolyte). All production procedures were performed in a dry atmosphere at a temperature of 30° C. or lower below the dew point.

A gel electrolyte layer was produced as follows. First, modified PVDF (7% hexafluoropropylene copolymer), an electrolyte solution (50% by weight of ethylene carbonate and 50% by weight of propylene carbonate added to 1.0 mol/kg LiPF₆), and DMC (dimethyl carbonate) were mixed and stirred at 50° C. to be dissolved, thereby obtaining a sol electrolyte precursor. The precursor had a composition of PVDF:electrolyte solution:DMC=1:6:12. The resulting precursor solution (sol electrolyte precursor) was uniformly applied to the surfaces of the positive electrode and the negative electrode. The DMC was then removed by drying at 85° C. for 3 min. Thus, the gel electrolyte layers were formed on the surfaces of the positive electrode and the negative electrode.

Next, a 9-μm thickness polyethylene separator cut out to a dimension larger than an electrode system and sandwiched between the positive electrode and the negative electrode was assembled into a battery case to produce a 2032 coin-type test battery. The resulting battery was then washed with ethanol and left at 60° C. overnight. The battery was then subjected to battery evaluation in the same manner as in Example 1.

As a result, the 0.2C initial discharge capacity was 145 mAh/g, the initial charge/discharge efficiency was 86.3%, and the capacity maintenance rate at 2C discharge was 78%.

### Comparative Example 8

A coin-type test battery was produced in the same manner as in Example 18, except that acetylene black was used as the electrical conductive assistant for the positive electrode, and the battery was evaluated in the same manner as in Example 18. As a result, the 0.2C initial discharge capacity was 120 mAh/g, the initial charge/discharge efficiency was 82.2%, and the capacity maintenance rate at 2C discharge was 15%.

### Experiment 11: Investigation of Dry Electrode

### Example 19

While 95% by weight of NCM523 and 1% by weight of Carbon material A were mixed in a V blender, a mixed emulsion of PTFE (solid content: 2% by weight) and PVDF (solid content: 2% by weight) was added dropwise thereto in plural times, and the resultant was mixed for 3 hours, removed from the V blender, and then dried at 110° C. for 3 hours. Subsequently, a powder for a positive electrode material with an average particle size of 30 μm was obtained by an air classifier while pulverizing the dried resultant by a jet mill. Then, the powder for the positive electrode material was uniformly applied by spraying onto a positive electrode current collecting foil in which a thin layer of a paste composed of PVDF and Carbon material A was applied on an aluminum foil, and the resultant was continuously fed into a hot roll press which had been heated to 130 to 200° C. to obtain a pressure-molded dry electrode.

Thereafter, a 2032 coin-type test battery was produced in the same manner as in Example 1 and subjected to the battery evaluation. As a result, the 0.2C initial discharge capacity was 140 mAh/g, the initial charge/discharge efficiency was 85.1%, and the capacity maintenance rate at 2C discharge was 80%.

### Comparative Example 9

A coin-type test battery was produced in the same manner as in Example 19, except that acetylene black was used as the electrical conductive assistant for the negative electrode, and the battery was evaluated in the same manner as in Example 19. As a result, the 0.2C initial discharge capacity was 118 mAh/g, the initial charge/discharge efficiency was 83.0%, and the capacity maintenance rate at 2C discharge was 22%.

### Experiment 12: Investigation of Semi-Solid Battery Using Clay-Type Electrode

### Example 20

A 1 M LiPF₆ solution (mixed solvent with 1:1 volume ratio of ethylene carbonate (EC):diethyl carbonate (DEC)) was used as an electrolytic solution, and 45 cm³ of NCM523, 8 cm³ of Carbon material A, and 47 cm³ of the electrolyte solution were measured into a small batch mixer container using a graduated cylinder. A positive electrode material slurry was prepared by mixing in the mixer equipped with a roller mill adapter at 100 rpm at 8° C. for 6 minutes. Measurement with an electrical conductivity tester confirmed 8.2×10⁻³ S/cm.

The positive electrode material slurry was applied at a constant rate by a discharge-type applicator on a 15-μm thickness aluminum foil which had been cut into 2-cm squares to obtain a clay-type positive electrode with a thickness of 200 μm. The clay-type positive electrode and a 2-cm square metallic lithium were then promptly placed so as to be opposite each other with a 2.5-cm square separator therebetween. The resultant was sandwiched between aluminum laminated films, a current collecting tab which had previously been installed on each electrode was led out to outside, and periphery thereof was heat-sealed to produce a pouch-type test battery. Note that all procedures were performed in a dry atmosphere at a temperature of 30° C. or lower below the dew point.

The pouch-type test battery was then subjected to battery evaluation in the same manner as in Example 1. As a result, the 0.2C initial discharge capacity was 143 mAh/g, the initial charge/discharge efficiency was 84.7%, and the capacity maintenance rate at 2C discharge was 71%.

### Comparative Example 10

A pouch-type test battery was produced in the same manner as in Example 20, except that acetylene black was used as the electrical conductive assistant for a negative electrode, and the battery was evaluated in the same manner as in Example 20. As a result, the 0.2C initial discharge capacity was 120 mAh/g, the initial charge/discharge efficiency was 81.7%, and the capacity maintenance rate at 2C discharge was 12%.

### Experiment 13: Investigation of Graphite Negative Electrode

### Example 21

A negative electrode agent paste was produced by stirring and mixing 97% by weight of artificial graphite, 1% by weight of Carbon material A serving as an electrical conductive assistant, 1% by weight of carboxymethyl cellulose, and 1% by weight of a styrene-butadiene rubber (SBR) in distilled water serving as a solvent so as to be uniform. The resulting paste was applied onto a 20-μm thickness copper foil and allowed to dry. The resultant was punched out to 15 mm in diameter and pressed to obtain a negative electrode.

In a glove box with an argon gas atmosphere, the obtained negative electrode and a metallic Li punched to φ 16 mm were used to sandwich a 25-μm thickness separator (polypropylene microporous membrane) so as to oppose the negative electrode composite layer and the metallic Li, a 1 M LiPF₆ solution (mixed solvent with 1:1 volume ratio of ethylene carbonate (EC):diethyl carbonate (DEC)) was added as an electrolyte solution, and the resultant was caulked and sealed to produce a 2032 coin-type test battery. The test battery was then washed with ethanol and subjected to the below-described battery evaluation.

The test battery was applied with a constant current of 1.23 mA (equivalent to 0.2 C) per test battery up to 0 V, after reaching 0 V, charging was performed at a constant voltage and continued up to 0.31 mA (0.05 C). After that, discharging was then performed up to 1.5 V at a constant current of 1.23 mA. Charging was performed in the same manner, followed by discharge at a constant current of 12.3 mA (equivalent to 2 C), and the voltage was measured for one second after the start of discharge.

As a result, the voltage for one second after the start of discharge was 0.27 V. The DC resistance obtained by dividing the voltage by the current was 22Ω.

### Comparative Example 11

A coin-type test battery was produced in the same manner as in Example 21, except that acetylene black (product name: DENKA BLACK, manufactured by Denka Company Limited) was used as the electrical conductive assistant instead of Carbon material A, and the battery was evaluated in the same manner as in Example 21. As a result, the voltage for one second after the start of discharge was 0.32 V. The DC resistance obtained by dividing the voltage by the current was 26Ω.

### Experiment 14: Investigation of Silicon-Based Negative Electrode

### Example 22

Carbon material A serving as an electrical conductive assistant and a binder were incorporated into a Si—C powder (made by Zichen, China, average particle size: 10 μm, 2 m²/g) serving as a negative electrode active material. The blending ratio was Si—C powder:Carbon material A:binder=85:5:10, and water was added thereto to produce a slurry. The slurry was then applied to a 20-μm thickness Cu current collector, and the resultant was dried at 110° C., punched out to Φ 15 mm, and pressurized at 30 kN to obtain a negative electrode. The negative electrode was vacuum-dried at 120° C., and then in a glove box with an argon gas atmosphere, a 2032 coin-type test battery in which the counter electrode was metallic Li was produced using a 1 M LiPF₆ solution (mixed solvent with 1:1 volume ratio of ethylene carbonate (EC):diethyl carbonate (DEC)) serving as the electrolyte solution and a polypropylene separator.

The test battery was applied with a current up to 0 V (vs Li/Li⁺) at 0.2 A/g per negative electrode active material, and was charged until the current reached 0.01 A/g. Then, a current of 0.5 A/g was applied up to 2.0 V (vs Li/Li⁺), and discharge was completed. Next, the cycle of charging followed by discharging was repeated 10 times in the same manner. For the resulting test battery, the charge/discharge efficiency at the first cycle (1^{st} CE), the initial discharge capacity, and the charge/discharge efficiency at the tenth cycle (10^{th} CE) were measured.

As a result, the charge/discharge efficiency at the first cycle was 87.0%, the initial discharge capacity was 1780 mAh/g, and the charge/discharge efficiency at the 10th cycle was 89.2%.

### Comparative Example 12

A coin-type test battery was produced and evaluated in the same manner as in Example 12, except that acetylene black was used instead of Carbon material A and the blending ratio of the negative electrode material was Si—C powder:acetylene black:binder=80:10:10. As a result, the charge/discharge efficiency at the first cycle was 83.6%, the initial discharge capacity was 1630 mAh/g, and the charge/discharge efficiency at the 10th cycle was 86.3%.

As shown in Examples 18 to 22, the carbon material of the present invention can be suitably used for various electrolyte solution systems and electrode systems in addition to ordinary liquid electrolyte (electrolyte solution) batteries, and positive electrodes and negative electrodes of such batteries. For a battery using a semi-solid electrolyte (gel electrolyte), a polymer is swollen to hold an electrolyte solution. It is believed that the carbon material of the present invention also holds an electrolyte solution therein, and thus achieves favorable properties. In a positive electrode and a negative electrode using the carbon material of the present invention with such a property of holding an electrolyte solution, the movement of the electrolyte (electrolyte motion) suppresses, and when the carbon material of the present invention is used in a battery, a stable battery reaction and excellent cycle life are achieved.

Furthermore, for a dry electrode battery which can be produced in a simplified manufacturing process and for a semi-solid lithium ion battery with a clay-type electrode which can have a thicker electrode to reduce the amount of the current-collecting foils and improve a battery capacity, higher performance can be achieved than in the Comparative Examples, making it possible to suitably achieve a high-performance battery.

### EXPLANATION OF REFERENCE NUMERALS

50 Device
41 Radiation thermometer
42 Sample holder
43 High frequency induction coil
200 Lithium ion battery
211 Outer component
212 Positive electrode
213 Outer component
214 Negative electrode
215 Separator
217 Sealing gasket
218 Spring
219 Spacer
P1 Cold negative electrode Pirani gauge
P2 Capacitance gauge
QMS Quadrupole mass spectrometer
TMP Turbo molecular pump
RP Rotary pump

1-35. (canceled)

36. A carbon material comprising:
a combined structure having an extended shape in which a plurality of hollow particulate parts is combined in a bead-chain-like configuration, the hollow particulate parts each comprising a surrounding wall that forms a comparted interior space of the hollow particulate parts and has a plurality of pores and a crystal structure of graphene,
the carbon material having an intensity ratio (I_{G}/I_{2D}) of an intensity of a G band (I_{G}) to an intensity of a 2D band (I_{2D}) in a Raman spectrum obtained by Raman spectrometry of 0.40 or more and 5.00 or less, and
the carbon material having an oil absorption of 400 mL/100 g or more in accordance with JIS K5101-13-1:2004.

37. The carbon material according to claim 36, wherein an intensity ratio (I_{D}/I_{G}) of an intensity of a D band (I_{D}) to the intensity of the G band (I_{G}) in the Raman spectrum is 0.1 or more and 10.0 or less.

38. The carbon material according to claim 36, wherein a mode pore size is 1 nm or more and 500 nm or less.

39. The carbon material according to claim 36, wherein a total pore volume is 0.10 cc/g or more and 20.00 cc/g or less.

40. The carbon material according to claim 36, wherein a ratio of a macropore volume to a total pore volume is 5% or more.

41. The carbon material according to claim 36, wherein an apparent density is 2.00 g/cc or less.

42. The carbon material according to claim 36, wherein a BET specific surface area is 100 m²/g or more and 2700 m²/g or less.

43. The carbon material according to claim 36, wherein a crystallite size Lc(002) in a c-axis direction measured by an X-ray diffraction method is 0.10 nm or more and 20.00 nm or less.

44. The carbon material according to claim 36, wherein an interplanar distance d002 between (002) planes measured by an X-ray diffraction method is 3.0 Å or more and 5.0 Å or less.

45. The carbon material according to claim 36, wherein a D50 obtained from a volume-based particle size distribution curve measured by a laser diffraction scattering method is 1 μm or more and 100 μm or less.

46. The carbon material according to claim 36, wherein a ratio (D90/D10) of a D90 to a D10 obtained from a volume-based particle size distribution curve measured by a laser diffraction scattering method is 100 or less.

47. The carbon material according to claim 36, wherein a value obtained by dividing a ratio (D90/M) of a D90 obtained from a volume-based particle size distribution curve measured by a laser diffraction scattering method to a mode pore size M by 1000 is 50 or less.

48. The carbon material according to claim 36, wherein the combined structure is a graphene mesosponge.

49. The carbon material according to claim 36, wherein the carbon material is for use in a secondary battery.

50. A dispersion liquid comprising:
the carbon material according to claim 36; and
a dispersion medium,
the carbon material being dispersed in the dispersion medium.

51. A composition for an electrode comprising:
the carbon material according to claim 36;
an active material; and
a binder.

52. A slurry for an electrode comprising:
the composition for an electrode according to claim 51; and
a dispersion medium,
the composition for an electrode being dispersed in the dispersion medium.

53. An electrode comprising the carbon material according to claim 36.

54. The electrode according to claim 53, wherein the electrode comprises 0.1 wt % or more and 6.0 wt % or less of the carbon material.

55. A positive electrode comprising the carbon material according to claim 36.

56. A negative electrode comprising the carbon material according to claim 36.

57. The negative electrode according to claim 56, wherein the negative electrode is a negative electrode for a lithium ion battery and further comprises graphite.

58. The negative electrode according to claim 56, wherein the negative electrode is a negative electrode for a lithium ion battery and further comprises silicon.

59. A lithium ion battery comprising:
the positive electrode according to claim 55;
a negative electrode comprising a carbon material comprising:
a combined structure having an extended shape in which a plurality of hollow particulate parts is combined in a bead-chain-like configuration, the hollow particulate parts each comprising a surrounding wall that forms a comparted interior space of the hollow particulate parts and has a plurality of pores and a crystal structure of graphene,
the carbon material having an intensity ratio (I_{G}/I_{2D}) of an intensity of a G band (I_{G}) to an intensity of a 2D band (I_{2D}) in a Raman spectrum obtained by Raman spectrometry of 0.40 or more and 5.00 or less, and
the carbon material having an oil absorption of 400 mL/100 g or more in accordance with JIS K5101-13-1:2004; and
a liquid electrolyte.

60. A lithium ion battery comprising:
the positive electrode according to claim 55;
a negative electrode comprising a carbon material comprising:
a combined structure having an extended shape in which a plurality of hollow particulate parts is combined in a bead-chain-like configuration, the hollow particulate parts each comprising a surrounding wall that forms a comparted interior space of the hollow particulate parts and has a plurality of pores and a crystal structure of graphene,
the carbon material having an intensity ratio (I_{G}/I_{2D}) of an intensity of a G band (I_{G}) to an intensity of a 2D band (I_{2D}) in a Raman spectrum obtained by Raman spectrometry of 0.40 or more and 5.00 or less, and
the carbon material having an oil absorption of 400 mL/100 g or more in accordance with JIS K5101-13-1:2004; and
a semi-solid electrolyte.

61. The lithium ion battery according to claim 59, wherein at least one of the positive electrode or the negative electrode is a dry electrode.

62. The lithium ion battery according to claim 60, wherein at least one of the positive electrode or the negative electrode is a dry electrode.

63. A lithium ion battery comprising:
a clay-type positive electrode including the carbon material according to claim 36; and
a clay-type negative electrode including a carbon material comprising:
a combined structure having an extended shape in which a plurality of hollow particulate parts is combined in a bead-chain-like configuration, the hollow particulate parts each comprising a surrounding wall that forms a comparted interior space of the hollow particulate parts and has a plurality of pores and a crystal structure of graphene,
the carbon material having an intensity ratio (I_{G}/I_{2D}) of an intensity of a G band (I_{G}) to an intensity of a 2D band (I_{2D}) in a Raman spectrum obtained by Raman spectrometry of 0.40 or more and 5.00 or less, and
the carbon material having an oil absorption of 400 mL/100 g or more in accordance with JIS K5101-13-1:2004.

64. A lithium ion battery comprising the carbon material according to claim 36.

65. A method for producing the carbon material according to claim 36, the method comprising:
removing a template material from a carbon material precursor to thereby obtain a carbon material, the carbon material precursor comprising the template material that is an agglomerate of a plurality of primary particles agglomerated in a bead-chain-like configuration and a carbonaceous layer that covers a surface of the template material.

66. The method according to claim 65, further comprising heating the carbon material at a temperature of 1000° C. or more and 3000° C. or less after the removing.

67. The method according to claim 65, wherein the template material is a fumed compound.

68. A carbon material precursor comprising:
a template material composed of an agglomerate of a plurality of primary particles agglomerated in a bead-chain-like configuration; and
a carbonaceous layer covering a surface of the template material and having a plurality of pores.

69. A method for producing the carbon material precursor according to claim 68, the method comprising:
covering a surface of a template material that is an agglomerate of a plurality of primary particles agglomerated in a bead-chain-like configuration with a carbonaceous layer to thereby obtain the carbon material precursor.

70. The method according to claim 69, wherein the template material is a fumed compound.
